(19) United States
(12) Patent Application Publication
(10) Pub. No.: US 2009/0109484 A1
(43) Pub. Date: Apr. 30, 2009

(54) Information processing apparatus and information processing method

(75) Inventor: Tadashi Honda, Kanagawa (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/285,451

(22) Filed: Oct. 6, 2008

(30) Foreign Application Priority Data
Oct. 31, 2007 (JP) 2007-284201

(51) Int. Cl. G06K 1/00

(52) U.S. Cl. 358/1.15

(57) ABSTRACT

An information processing apparatus and an information processing method capable of easily customizing and expanding a function are disclosed. The disclosed information processing apparatus includes a parts controlling unit causing software parts to execute a process based on connecting relationships each related to input/output of information between plural software parts; an image data set acquiring unit, as one of the software parts, acquiring image data set and outputting the acquired image data set to software parts connected to an output of the image data set acquiring unit in the connecting relationships; and an information extracting unit, as one of the software parts, extracting information recorded in a pattern embedded in the image data set input from software parts connected to an input of the information extracting unit in the connecting relationships. The parts controlling unit connects the information extracting unit at the output of the image data set acquiring unit.

### CROSS-REFERENCE TO RELATED APPLICATIONS

The present application claims priority under 35 U.S.C §119 to Japanese Patent Application Publication No. 2007-284201 filed Oct. 31, 2007, the entire contents of which are hereby incorporated herein by reference.

### BACKGROUND OF THE INVENTION

1. Field of the Invention

The present invention generally relates to an information processing apparatus and an information processing method, and particularly to an information processing apparatus and an information processing method in which functions are created and carried out by interconnecting plural software parts.

2. Description of the Related Art

Recently and continuing, in each of image forming apparatuses such as a printer, a copier, a scanner, a facsimile machine and a multi-functional peripheral including those functions in a single chassis, a CPU like general-purpose computers is mounted, though the memory capacity may be limited compared with such computers. Further, each of the functions implemented in such apparatuses is carried out by controlling applications installed in the apparatuses.

For example, in an image forming apparatus described in Japanese Patent No. 3679349, the functions commonly used by its applications are provided in its platform, and an implemented application may be carried out by using an API of the platform to use the functions in the platform. In such an image forming apparatus, it becomes possible to avoid repeatedly implementing such common functions upon installation of a new application, thereby improving the efficiency of developing the entire applications.

However, when granularity of the functions or interfaces of the platform is not adequately designed, the development efficiency of the applications may not be improved as it is desired.

More specifically, when the design of granularity is too fine in detail, even an application providing simple services may have to call many APIs, thereby complicating the source code.

On the other hand, when the design of granularity is too coarse, and an application providing a service realized by modifying a function provided by an interface of the platform is required to be implemented, it becomes necessary to modify the inside of the platform, which may increase the developing hours. Further, especially when there are complex dependent relationships existing between the modules of the platform, the situation may become more difficult because further modification of an existing part of the platform may become necessary in addition to the addition of a new function to the platform.

Further, for example, when it is necessary to implement a new application including a service (in this case, service of a data input function) that is required to be modified from an existing application, there may be drawbacks including that the services of the existing application other than the service to be modified may not be called. Therefore, it becomes necessary to develop a new application by describing source code of not only the data input function but also the other functions.

### SUMMARY OF THE INVENTION

The present invention is made in light of the problems and may provide an information processing apparatus and an information processing method in which, for example, a function of the apparatus may easily be customized and expanded.

According to an aspect of the present invention, there is provided an image forming apparatus including a parts controlling unit causing software parts to execute a process based on connecting relationships each relationship related to input/output of information between plural software parts; an image data set acquiring unit, as one of the software parts, acquiring image data set and outputting the acquired image data set to the software parts connected to an output of the image data set acquiring unit in the connecting relationships; and an information extracting unit, as one of the software parts, extracting information recorded in a pattern embedded in the image data set input from the software parts connected to an input of the information extracting unit in the connecting relationships, wherein the parts controlling unit connects the information-extracting unit at the output of the image data set acquiring unit.

In such an information processing apparatus, for example, it becomes possible to easily customize and expand a function.

According to an embodiment of the present invention, it is possible to provide an information processing apparatus and an information processing method in which, for example, a function of the apparatus may easily be customized and expanded.

### BRIEF DESCRIPTION OF THE DRAWINGS

Other objects, features, and advantages of the present invention will become more apparent from the following description when read in conjunction with the accompanying drawings, in which:

FIG. 1 is a drawing showing an exemplary hardware configuration of an image forming apparatus according to an embodiment of the present invention;

FIG. 2 is a drawing showing an exemplary software configuration of an image processing apparatus according to an embodiment of the present invention;

FIG. 3 is drawing illustrating a concept of pipes and filters architecture;

FIG. 4 is a drawing showing examples of combinations of filters to realize functions;

FIG. 5 is a drawing showing elements of a filter;

FIG. 6 is a drawing showing elements of an activity;

FIGS. 7A is a drawing illustrating an embedding stage of a refresh copy function;

FIG. 7B is a drawing illustrating a reading stage of the refresh copy function;

FIGS. 8 and 9 are sequence diagrams showing a process according to a first embodiment of the present invention;

FIG. 10 is a drawing showing an exemplary preference tree of a first job of a refresh copy detecting activity;

FIG. 11 is a drawing showing an example of a refresh copy detecting operation menu;

FIG. 12 is a drawing showing an exemplary job tree of the first job of the refresh copy detecting activity;

FIG. 13 is a drawing showing an exemplary preference tree of a second job of the refresh copy detecting activity;

FIG. 14 is a drawing showing an exemplary job tree of the second job of the refresh copy detecting activity;

FIGS. 15 and 16 are sequence diagrams showing a process according to a second embodiment of the present invention;

FIG. 17 is a drawing showing an exemplary preference tree of a security trace detecting activity;

FIG. 18 is a drawing showing an exemplary job tree of the security trace detecting activity;

FIG. 19 is a drawing showing an example of a security trace detecting operation menu;

FIGS. 20 and 21 are sequence diagrams showing a process according to a third embodiment of the present invention;

FIG. 22 is a drawing showing an exemplary preference tree of a falsification detecting activity;

FIG. 23 is a drawing showing an example of a falsification detecting operation menu; and

FIG. 24 is a drawing showing an exemplary job tree of the falsification detecting activity.

### DETAILED DESCRIPTION OF THE PREFERRED EMBODIMENTS

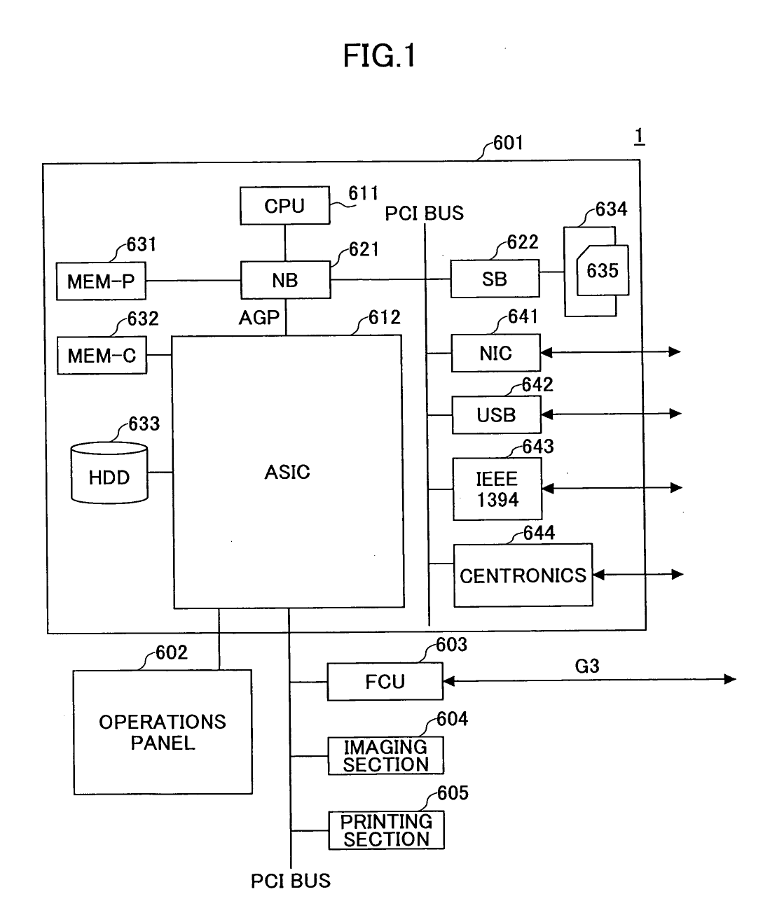

In the following, embodiments of the present invention are described with reference to the accompanying drawings. In the following embodiments, an image forming apparatus is described as an example of the information processing apparatus. FIG. 1 shows an exemplary hardware configuration of an image forming apparatus according to an embodiment of the present invention. In FIG. 1, a multi-functional peripheral 1 including plural functions of, for example, a printer, a copier, a scanner, and a facsimile machine in its chassis is shown as an example of the image forming apparatus.

As a hardware configuration shown in FIG. 1, the multi-functional peripheral 1 includes a controller 601, an operations panel 602, a facsimile control unit (FCU) 603, an imaging section 604, and a printing section 605.

The controller 601 includes a CPU 611, an ASCIC 612, an NB 621, an SB 622, an MEM-P 631, an MEM-C 632, an HDD (Hard Disk Drive) 633, a memory card slot 634, a NIC (Network Interface Controller) 641, a USB device 642, an IEEE 1394 device 643, and a Centronics device 644.

The CPU 611 is an IC for executing various information processes. The ASIC 612 is an IC for various image processing. The NB 621 is the north bridge of the controller 601. The SB 622 is the south bridge of the controller 601. The MEM-P 631 is a system memory of the multi-functional peripheral 1. The MEM-C 632 is a local memory of the multi-functional peripheral 1. The HDD 633 is a storage device of the multi-functional peripheral 1. The memory card slot 634 is a slot for receiving a memory card 635. The NIC 641 is a controller for network communication based on its MAC address. The USB device 642 provides a connection terminal conforming to the USB standard. The IEEE 1394 device 643 provides a connection terminal conforming to the IEEE 1394 standard. The Centronics device 644 provides a connection terminal conforming to the Centronics standard. The operations panel 602 is hardware (operations section) where a user inputs an instruction to the multi-functional peripheral 1 and acquires the output from the multi-functional peripheral 1.

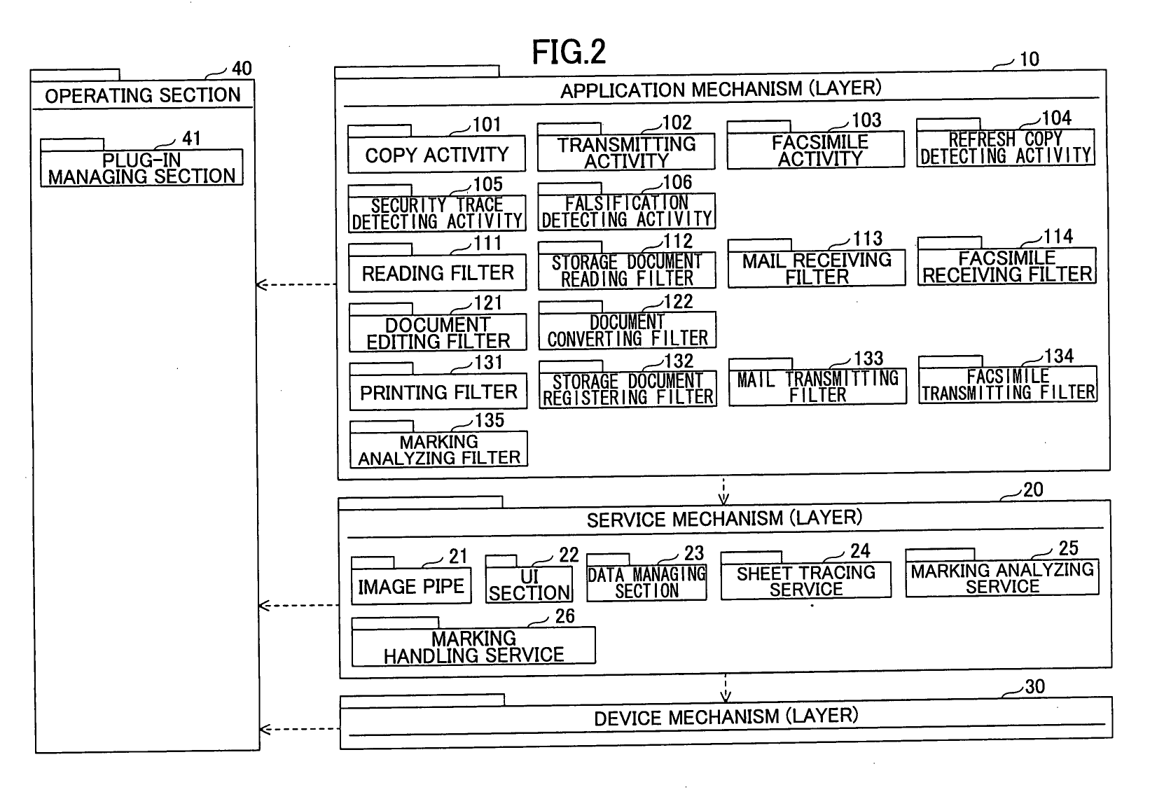

FIG. 2 shows a software configuration of an image forming apparatus according to an embodiment of the present invention. As shown in FIG. 2, the software layers in the multi-functional peripheral 1 includes an application mechanism (layer) 10, a service mechanism (layer) 20, a device mechanism (layer) 30, and an-operating section (layer) 40. The hierarchical relationships between layers are based on calling relationships between the layers. Namely, in the figure, basically, an upper layer calls its lower layer. The software of FIG. 2 is stored in the HDD 633 and the like, and loaded into the MEM-P 631 upon the execution of the software so that the CPU 611 executes the function of the software.

The application mechanism (layer) 10 includes software parts (programs) that allow a user to use the resources such as functions and information (data) provided by the multi-functional peripheral 1. In the embodiments, some of the software parts implemented in the application mechanism 10 are called “filters”. This is because the application executing a job of the multi-functional peripheral 1 is based on the software architecture called “pipes & filters”.

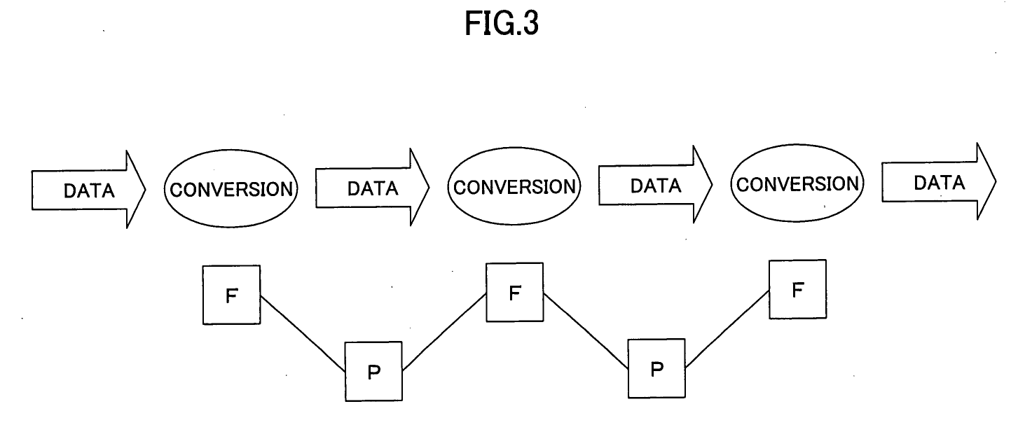

FIG. 3 illustrates the concept of the “pipes & filters” architecture. In FIG. 3, characters “F” and “P” denote filters and pipes, respectively. As shown in FIG. 3, the filters are connected to each other by interposing pipes. The filters convert input data and output the converted result. The pipe may be provided in a storage region where both of the connecting filters are accessible, and transmits the data from one filter to another filter.

That is, in a multi-functional peripheral 1 according to an embodiment of the present invention, the job may be regarded as a series of “conversions” with respect to a document (data). The job in the multi-functional peripheral 1 may be generalized as a series of input, process, and output of a document (data). Then, each of the “input”, “process”, and “output” is regarded as one of the “conversions”, and a software product realizing one of the “conversions” is regarded as a filter. A filter realizing an input is called “an input filter”. Similarly, a filter realizing processing is called “a processing filter”. Further, a filter realizing an output is called “an output filter”. Basically, each filter alone cannot carry out a single job, that is, an application executing a single job is constituted by connecting plural filters as shown in FIG. 3.

It should be noted that each filter is independent from each other, and there is no dependent relationship (calling relationship) between filters. Because of this feature, a single filter can be installed or uninstalled independently.

In FIG. 2, as the input filters, the application mechanism 10 includes a reading filter 111, a storage document reading filter 112, a mail receiving filter 113, and a facsimile receiving filter 114.

The reading filter 111 controls reading of image data set by a scanner and outputs the read image data set. The storage document reading filter 112 reads the document data (image data set) in the storage device and outputs the read data. The mail receiving filter 113 receives electronic mail and outputs data in the electronic mail. The facsimile receiving filter 114 controls facsimile reception and outputs the received printing data.

Further, as shown in FIG. 2, the processing filters include a document editing filter 121 and a document converting filter 122. The document editing filter 121 performs a prescribed processing (adjusting gray scale, changing multiplication, rotating, combining pages, and the like) on input data and outputs the processed data. The document converting filter 122 converts the data format of image data set. For example, the document converting filter 122 performs a rendering process, namely converting from input PostScript data into bitmap data.

Further, as shown in FIG. 2, the output filters include a printing filter 131, a storage document registering filter 132, a mail transmitting filter 133, a facsimile transmitting filter 134, and a marking analyzing filter 135.

The printing filter 131 outputs (prints) input data to a plotter. The storage document registering filter 132 stores input data in a storage device such as the HDD 633 in the multi-functional peripheral 1. The mail transmitting filter 133 attaches input data to electronic mail and transmits the electronic mail with the data. The facsimile transmitting filter 134 transmits input data as facsimile data. The marking analyzing filter 135 analyzes (including extracts information embedded in the marking) a marking (such as a barcode and a woven pattern) embedded in input image data set and outputs the analyzed result.

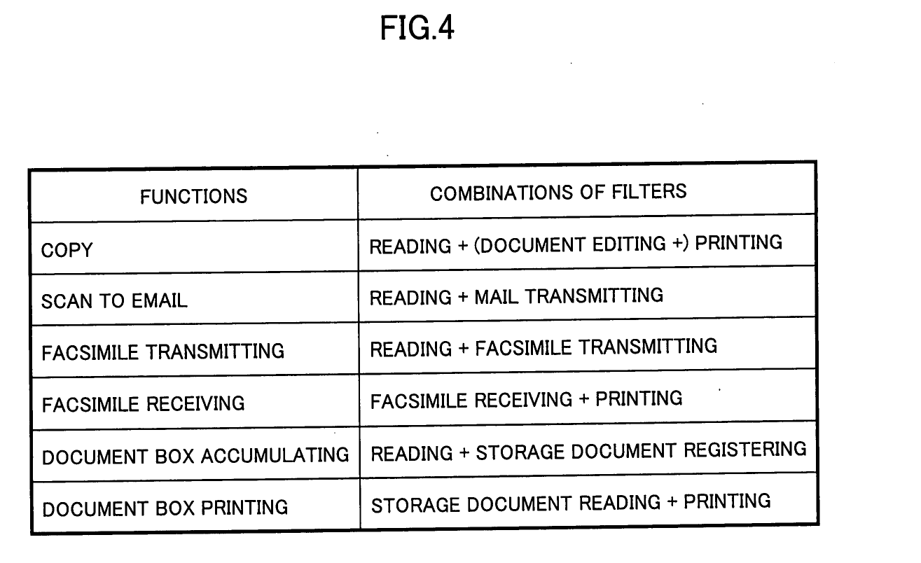

Each function in the multi-functional peripheral 1 may be realized by combing the filters. FIG. 4 shows some examples of the combination of the filters to realize functions in the multi-functional peripheral 1.

For example, the copy function may be realized by connecting the reading filter 111 and the printing filter 131. This is because the copy function may be realized by reading image data set from a draft by the reading filter 111 and printing the image data set by the printing filter 131. It should be noted that when a processing such as combining pages and enlarging or reducing sizes of data is required, the document editing filter 121 to realize such processes may be interposed between the above two filters.

On the other hand, the scan to e-mail function (to transmit scanned data via e-mail) may be realized by connecting the reading filter 111 and the mail transmitting filter 133. The facsimile transmitting function may be realized by connecting the reading filter 111 and the facsimile transmitting filter 134. The facsimile receiving function may be realized by connecting the facsimile receiving filter 114 and the printing filter 131. The document box accumulating function (to store scanned image data set into the multi-functional peripheral 1) may be realized by connecting a reading filter 111 and the storage document registering filter 132. The document box printing function (to print document data stored in the multi-functional peripheral 1) may be realized by connecting the storage document reading filter 112 and the printing filter 131.

As shown in FIG. 4, for example, the reading filter 111 is used in four functions. As this case shows, each filter may be used in plural functions. Because of this feature, it may be possible to reduce development hours to develop each of the functions. Further, in the multi-functional peripheral 1, an application may be made by using filters as its parts. Therefore, it may become possible to customize or expand each function easily. That is, from a functional point of view, there is no dependent relationship between filters, and each filter is independent of each other. Because of this feature, a new application may be developed easily by, for example, adding a new filter or changing the combination of the filters. As a result, advantageously, when there is a new application to be implemented and the application includes a function that cannot be realized by the current filters, what is to be done is to develop and install only a filter to assist in realizing the function. Therefore, in a layer lower than the application mechanism (layer) 10, it becomes possible to reduce the frequency of modification upon the implementation of a new application, thereby enabling making the platform more stable.

Further, the application mechanism 10 includes software parts called “activities”. Each of the activities manages a connecting order of plural filters and executes the filters according to the connecting order to execute a job. A single application is realized (performed) by a single activity.

As described above, basically, each filter is independent of the others. Because of this feature, it becomes possible to dynamically determine a combination of the filters to create an application. More specifically, for example, whenever a job execution request is received, it may become possible to allow a user to select filters to be used, an executing order of the selected filters, and execution conditions via the operations panel 602 to execute the function desired by the user.

However, as far as a general function frequently used such as a copy function is concerned, it may be troublesome for users to issue an execution request each time by selecting filters. To overcome this problem, the activity may be used. That is, by previously defining an activity as the combination (connecting relationships) of the filters, a user may select what is to be done by selecting the corresponding activity. The activity automatically executes the functions of the filters according to the combination (connecting order) of the filters in accordance with the definition of the activity. As a result, the activity may not only eliminate troublesome operations but also provide a similar operating environment to a user like a conventional user interface environment where a user selects an application to be executed in a conventional apparatus.

FIG. 2 shows exemplary activities: a copy activity 101, a transmitting activity 102, a facsimile activity 103, a refresh copy detecting activity 104, a security trace detecting activity 105, and a falsification detecting activity 106. For example, the copy activity 101 realizes a copy function (copy application) by combination of the reading filter 111, the document editing filter 121, and the printing filter 131. The refresh copy detecting activity 104 realizes a refresh copy function.

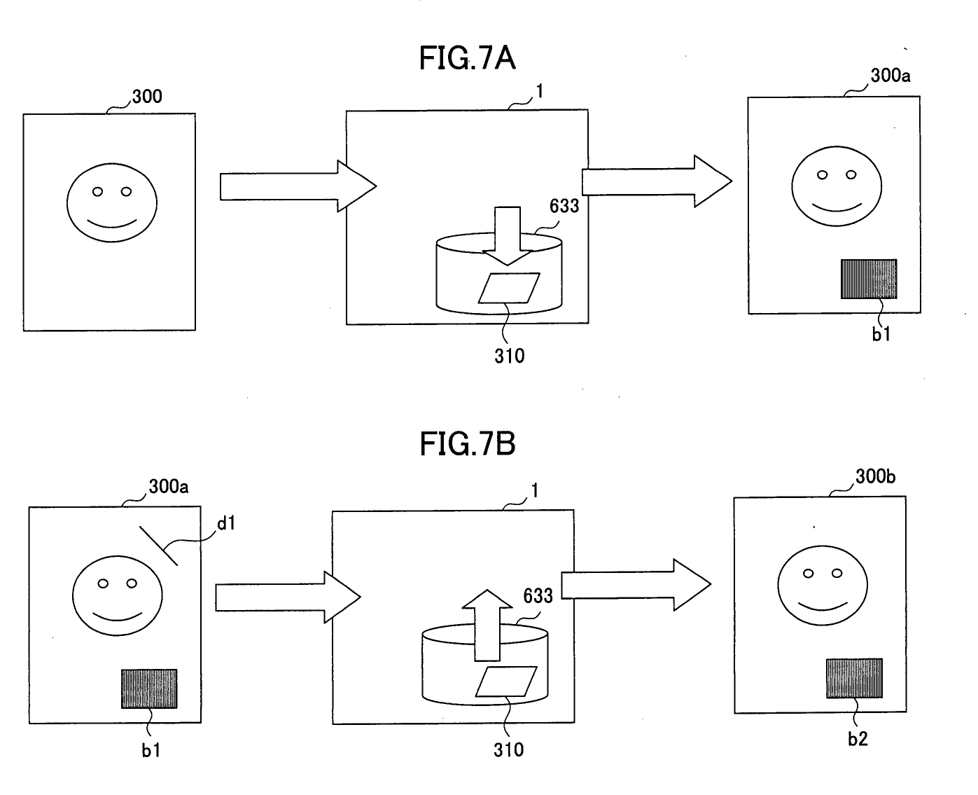

Next, the refresh copy function is described. FIGS. 7A and 7B are drawings illustrating the refresh copy function. The process of the refresh copy function may be divided into two stages: an embedding stage (refresh copy embedding process) as shown in FIG. 7A and a reading stage (refresh copy reading stage) as shown in FIG. 7B.

In the embedding stage of FIG. 7A, a sheet document 300 is copied by the multi-functional peripheral 1, and a sheet document 300a is output. In this case, a barcode “b1” is printed on the sheet document 300a as a marking indicating the sheet ID of the sheet document 300a. Further, the multi-functional peripheral 1 associates and stores an image data set 310 of the sheet document 300 with the sheet ID read from the sheet document 300 in the HDD 633. Herein, the sheet ID refers to identification information to uniquely distinguish sheet documents.

In the reading stage of FIG. 7B, a sheet document 300a is copied by the multi-functional peripheral 1, and a sheet document 300b is output. In this case, the multi-functional peripheral 1 identifies the sheet ID of the sheet document 300 by reading the barcode “b1” on the sheet document 300a, and outputs, as the sheet document 300b, a printing sheet on which the image data set 310 associated with the sheet ID and stored in the HDD 633 is printed. It should be noted that a barcode “b2” indicating a sheet ID different from that of the sheet document 300a is printed on the sheet document 300b.

Namely, in the reading stage of the refresh copy function as shown in FIG. 7B, not the image data set read from the sheet document 300a (Copy Source) but the image data set 310 stored in the embedding stage is to be printed. Because of this feature, for example, even when there is a note “d1” on the sheet document 300a, the note “d1” will not be printed on the sheet document 300b.

The refresh copy detecting activity 104 executes the reading stage of the refresh copy function.

The security trace detecting activity 105 analyzes information on a sheet document and marking (woven pattern in this embodiment) printed on the sheet document for the purpose of the security of the information printed on the sheet document, and outputs the analysis result.

The falsification detecting activity 106 detects whether the information on a sheet document is falsified based on the information and the marking (woven pattern in this embodiment) printed on the sheet document for the purpose of detecting the falsification of the information printed as the sheet document.

It should be noted that, basically, each activity is independent of each other and there is no dependent relationship (calling relationship) between the activities. Because of this feature, a single activity can be installed or uninstalled independently. Therefore, it is possible to create a new activity by combining necessary filters and installing the activity.

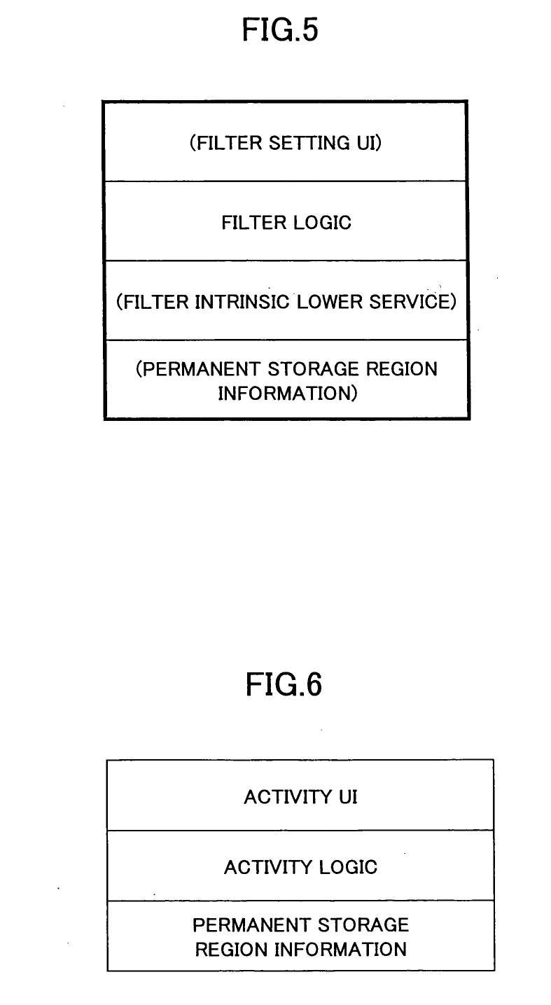

Next, the filter and the activity are described in more detail. FIG. 5 shows elements of a filter. As shown in FIG. 5, each filter may include filter setting UI (User Interface), filter logic, filter intrinsic lower service, and permanent storage region information. It should be noted that each of the filter setting UI, the filter intrinsic lower service, and the permanent storage region information is not always necessary depending on the filter.

The filter setting UI is a program for displaying a menu on the operations panel 602 and the like so that a user can set operating conditions and the like of the filter. Namely, the operating conditions are separately set for each filter. For example, the filter setting UI of the reading filter 111 may be a program for displaying a menu for setting draft type, reading size, resolution, and the like. It should be noted that when the operations panel 602 can display a menu based on HTML data and a script, the filter setting UI may be in HTML and script environments, respectively.

The filter logic is a program in which logic for realizing a function of the filter is implemented. Namely, by using the filter intrinsic lower service as an element of the filter, the service mechanism 20, and the like, the function of the filter is realized based on the operating conditions set through the filter setting UI. For example, the filter logic in the reading filter 111 may control draft reading in the scanner.

The filter intrinsic lower service is a lower function (library) necessary for realizing the filter logic.

The permanent storage region information corresponds to a schema definition of the data required to be stored in a non-volatile memory, the data including setting information of the filter (such as default values of the operating conditions). The schema definition is registered in the data management section 23 when the filter is being installed.

FIG. 6 shows elements of an activity. As shown in FIG. 6, an activity may include activity UI (User Interface), activity logic, and permanent storage region information.

The activity UI is information or a program for displaying a menu of the activity (a menu for setting operating conditions and the like of the activity) on the operations panel 602 and the like.

The activity logic is a program in which a process of the activity is implemented. Basically, the logic with respect to the combination of the filters (executing order of the filters, settings for the plural filters, change of connections of the filters, error processing, and the like) is implemented in the activity logic.

The permanent storage region information corresponds to a schema definition of the data required to be stored in a non-volatile memory, the data including setting information of the activity (default values of the operating conditions and the like). The schema definition is registered in the data management section 23 when the activity is being installed.

Referring back to FIG. 2, the service mechanism (layer) 20 includes software parts for providing a primitive service used by the activity, the filter, and the like and software products which makes applications independent of the hardware specification of each apparatus model and the like. In FIG. 2, the service mechanism 20 includes software parts such as an image pipe 21, a UI section 22, a data managing section 23, a sheet tracing service 24, a marking analyzing service 25, and a marking handling service 26.

The image pipe 21 realizes a function of the pipe. Namely, the image pipe 21 transmits the output data from a filter to the next filter using a memory area and the like. It should be noted that the pipe is depicted as a single block, however, in practical use, plural pipes may be generated in the same number as that of the created connections between filters.

The UI (User Interface) section 22 translates a user's request input through an operation menu on the operations panel 602 and requests a software product in the application mechanism 10, the service mechanism 20, or the like to perform a process control in accordance with the user's request. The data managing section 23 prescribes a storing method, storing place, and the like with respect to various information such as user information stored in and outside the apparatus.

The sheet tracing service 24 issues and manages a sheet ID for uniquely identifying a sheet document on which an image data set is printed by the multi-functional peripheral 1. The marking analyzing service 25 controls a process of analyzing a marking embedded in the image data set. The marking handling service 26 detects the marking from the image data set based on the conditions specified by the marking analyzing service 25.

The device mechanism 30 has means for controlling a device provided for each device of the multi-functional peripheral 1.

The operating section 40 includes software parts with respect to operational management of the system and is commonly used from the application mechanism 10, the service mechanism 20 and the device mechanism 30. In FIG. 2, the operating section 40 includes a plug-in managing section 41. The plug-in managing section 41 manages the information of the software parts such as the activities and filters that can be freely installed and uninstalled.

In the following, as the embodiments of the present invention in the multi-functional peripheral 1 including the software configuration as described above, detailed operations of the refresh copy detecting activity 104, the security trace detecting activity 105, and the falsification detecting activity 106 are described, each of the activities being capable of realizing an application by using the marking analyzing filter 135.

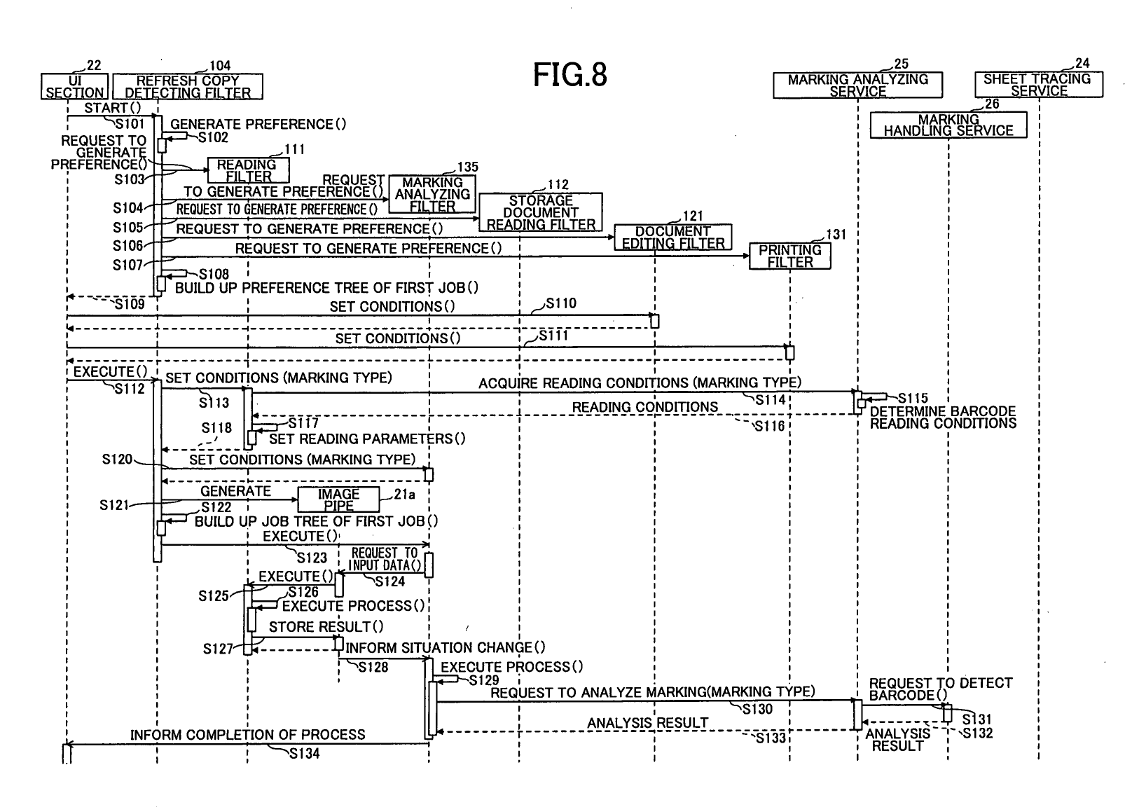

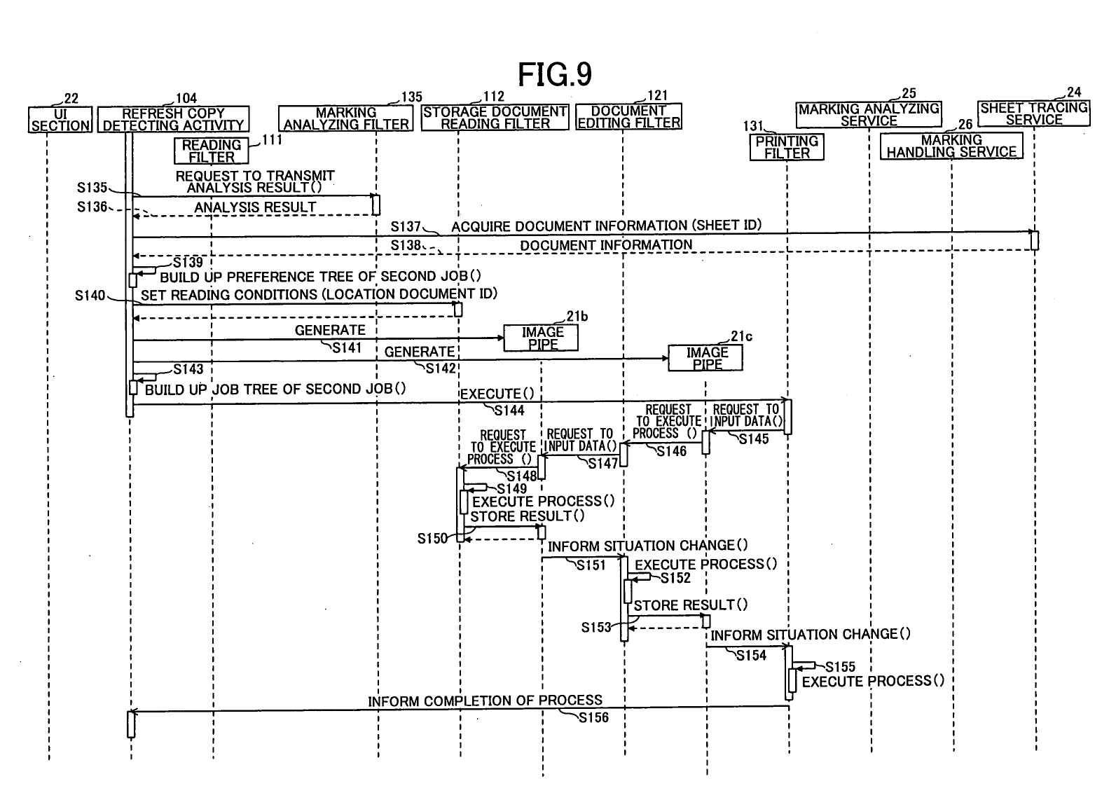

As a first embodiment of the present invention, a process of the refresh copy detecting activity 104 is described. FIGS. 8 and 9 are sequence diagrams showing a process according to the first embodiment of the present invention.

In step S101, when the refresh copy detecting activity 104 is selected to be executed by a user through an operation menu on the operations panel 602, the UI section 22 sends a request to the refresh copy detecting activity 104 to run. In step S102, the refresh copy detecting activity 104 responds to the request and generates an object to store the operating conditions of the refresh copy detecting activity 104 itself (hereinafter referred to as “a preference object”). The preference object refers to an instance of the classes where the parameters describing the operating conditions are defined as the attributes, and the elements of the class may be different depending on the activities and filters.

Next, in steps S103 through S107, the refresh copy detecting activity 104 sends a request to each of the filters (the reading filter 111, the marking analyzing filter 135, the storage document reading filter 112, the document editing filter 121, and the printing filter 131) to be used by the activity 104 to generate its preference object. Each of the filters generates its preference object intrinsic to the filter and transmits the generated preference object to the refresh copy detecting activity 104. It should be noted that default values are set in the attributes of the thus-generated reference objects of the refresh copy detecting activity 104 and the filters.

Next, in step S108, based on a connecting relationship defined between the refresh copy detecting activity 104 and each of the filters (a using relationship between the refresh copy detecting activity 104 and each of the filters and a sequential relationship in the execution order of the filters), the refresh copy detecting activity 104 builds up information indicating the connecting relationship (preference tree) by generating relationships between the preference objects.

In the meantime, the refresh copy-detecting activity 104 executes two jobs to respond to a single execution request. The first job is to read image data set from a sheet document and identify the sheet ID by analyzing a marking embedded in the image data set (hereinafter referred to as “a first job”). In this job, the reading filter 111 and the marking analyzing filter 135 are used. The second job is to read the image data set associated with the sheet ID, convert the image data set, and print the converted image data set (hereinafter referred to as “a second job”). In this job, the storage document reading filter 112, the document editing filter 121, and the printing filter 131 are used. It should be noted that the second job is executed only when the sheet ID is correctly obtained in the first job. That is, the second job is not always executed. In this case, a preference tree with respect to the first job is being built up in step S108.

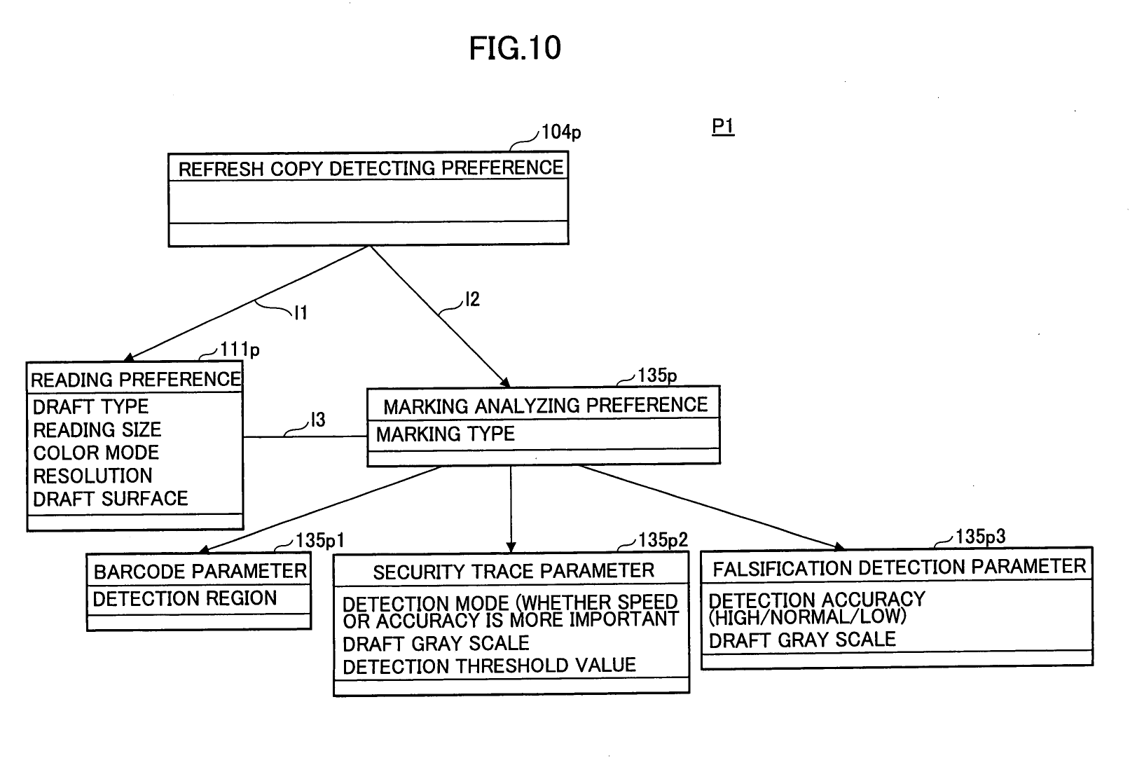

FIG. 10 shows an example of a preference tree “P1” with respect to the first job of the refresh copy detecting activity 104.

As shown in FIG. 10, the preference tree “P1” includes a refresh copy detecting preference 104p, the reading preference 111p and the marking analyzing preference 135p, which are the preference objects of the refresh copy detecting activity 104, the reading filter 111, and the marking analyzing filter 135, respectively.

The reading preference 111p includes parameters such as draft type, reading size, color mode, resolution, and draft surface. The marking analyzing preference 135p includes parameters such as marking type. The marking type is the information indicating the marking itself to be analyzed or a kind of the usage of the marking. In this embodiment, a value of “barcode”, “security trace”, or “falsification detection” may be set as the marking type. Further, depending on the value of the marking type, the marking analyzing preference 135p may include a barcode parameter 135p1, a security trace parameter 135p2, or a falsification detection parameter 135p3. The barcode parameter 135p1 becomes effective when the marking type is “barcode” and includes a detection region. The detection region refers to a region where a marking is detected. The security trace parameter 135p2 and the falsification detection parameter 135p3 are described in second and third embodiments, respectively, of the present invention.

Relationships 11 and 12 from the refresh copy detecting preference 104p to the other preference objects are generated based on the using relationship between the refresh copy detecting activity 104 and each of the filters. A relationship 13 between the preferences is generated based on the sequential relationship in the execution order of the filters. It should be noted that each of the relationships may be implemented based on a method where one preference object holds the identification information (such as reference data, a pointer, or an ID) of the other preference object as member variables.

In step S109, when the process to respond to the request to run is completed, the UI section 22 displays an operation menu of the refresh copy detecting activity 104 (refresh copy detecting operation menu) on the operations panel 602.

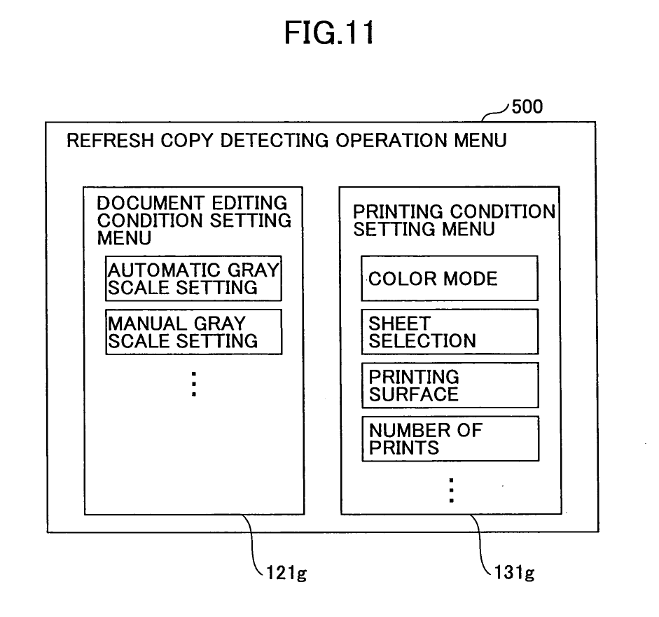

FIG. 11 shows an example of the refresh copy detecting operation menu. As shown in FIG. 11, the refresh copy detecting operation menu 500 may include a document editing condition setting region 121g and a printing condition setting region 131g. Each region is displayed by the UI section 22 based on the filter setting UI (see FIG. 5) of the corresponding filters. A user may set the operating conditions of each filter by operating each of the regions. It should be noted that the parameters of the operating conditions of each filter that can be set by a user in each region are based on the attributes of the preference object of the filter.

In step S110, for example, when operating conditions are set in the document editing condition setting region 121g, the UI section 22 informs the document editing filter 121 of the setting contents. To respond to the notice, the document editing filter 121 reflects (sets) the setting contents in a document editing preference 121p. In the same manner, in step S111, when operating conditions are set in the printing condition setting region 131g, the UI section 22 informs the printing filter 131 of the setting contents. To respond to the notice, the printing filter 131 reflects (sets) the setting contents in a printing preference 131p.

It should be noted that in the refresh copy detecting operation menu 500, there is no region for setting the operating conditions of the reading filter 111, the marking analyzing filter 135, and the storage document reading filter 112 among the filters used by the refresh copy detecting activity 104. This is because appropriate values are automatically set as the operating conditions of those filters to realize the reading stage of the refresh copy function.

Next, in step S112, when a request to start the job is input by a user by the pressing the start button on the operations panel 602, the UI section 22 sends a request to the refresh copy detecting activity 104 to run the job. In step S113, to respond to the request, by using the “marking type” as an argument of the marking type, the refresh copy detecting activity 104 sends a request to the reading filter 111 to set appropriate operating conditions corresponding to the marking type. In this refresh copy function, a barcode indicating a sheet ID is required to be read. Therefore, the “barcode” is selected as the value (data) of the marking type.

In step S114, to respond to the request, the reading filter 111 sends a request to the marking analyzing service 25 to return appropriate operating conditions (reading conditions) to read the selected marking type (barcode). In step S115, the marking analyzing service 25 determines appropriate reading conditions (about gray scale and resolution (600 dpi) and the like) to read the selected barcode. Then, in step S116, the marking analyzing service 25 transmits the reading conditions as a result of the determination to the reading filter 111. In step S117, the reading filter 111 sets the received reading conditions in the reading preference 111p.

Herein the reason that the marking analyzing service 25 determines reading conditions in accordance with the marking type is to maintain the versatility of the reading filter 111. Namely, the responsibility of the reading filter 111 is to read image data set from a sheet document. On the other hand, the reading filter 111 may be used by not only the refresh copy detecting activity 104 but also other activities such as the copy activity 101. In consideration of the responsibility and the versatility of the reading filter 111, it is undesirable to install a determination process with respect to a specific function such as reading or analyzing a marking into the reading filter 111. Therefore, the determination process of reading conditions in accordance with the marking type is arranged to be executed in the marking analyzing service 25 which is a software part specified to analyze the marking.

In step S118, the setting of the operating (reading) conditions is finished. Then, in step S120, the refresh copy detecting activity 104 sends a request to the marking analyzing filter 135 to set the operating conditions in accordance with the marking type using the marking type (barcode) as an argument. To respond to the request, the marking analyzing filter 135 sets a value of the marking type to be “barcode” and sets a value of the detection region of the barcode parameter 135p1.

Then, in step S121, based on the preference tree “P1”, the refresh copy detecting activity 104 generates an image pipe 21 for connecting filters used in the first job. Herein, based on a relationship 13 in the preference tree “P1” of FIG. 10, the image pipe 21a is generated for connecting the reading filter 111 and the marking analyzing filter 135.

Next, in step S122, based on the preference tree “P1”, the refresh copy detecting activity 104 establishes the connections between the refresh copy detecting activity 104, each filter, and the image pipe 21a. When the connections are established, a tree structure (hereinafter referred to as “job tree”) is built up representing a processing flow in the first job executed by the refresh copy detecting activity 104, the reading filter 111, the marking analyzing filter 135, and the image pipe 21a.

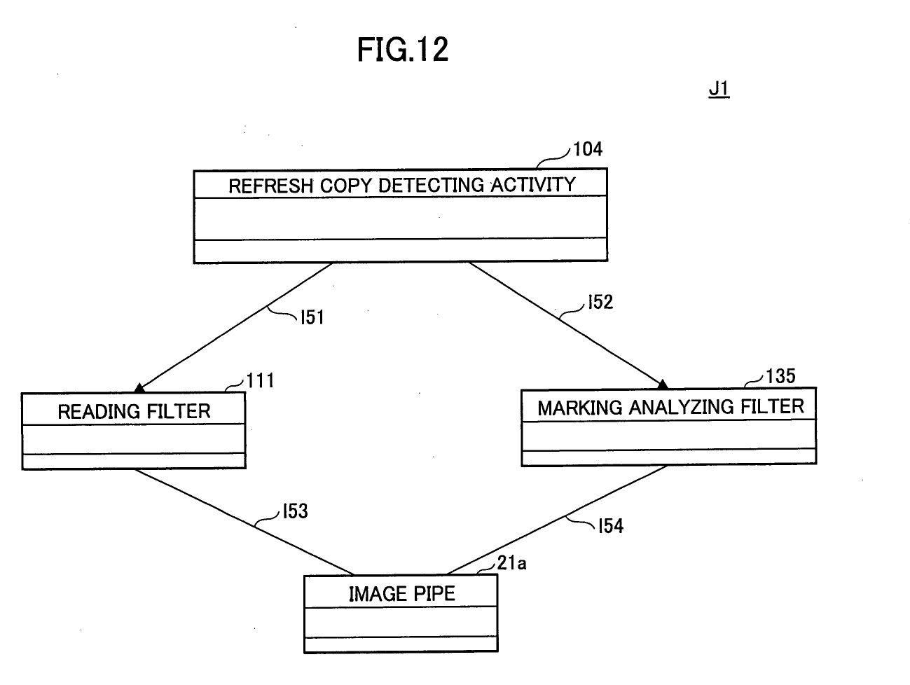

FIG. 12 shows an example of a job tree “J1” with respect to the first job of the refresh copy detecting activity 104. As shown in FIG. 12, the job tree “J1” may include the refresh copy detecting activity 104, the reading filter 111, the marking analyzing filter 135, and the image pipe 21a.

The connections (relationships 151 and 152) between the refresh copy detecting activity 104 and each of the filters are established based on the relationships 11 and 12, respectively, in the preference tree “P1”. Further, each of the connection (relationship 153) between the reading filter 111 and the image pipe 21a and the connection (relationship 154) between the image pipe 21a and the marking analyzing filter 135 is established based on the relationship 13 in the preference tree “P1”.

As described above, a job tree built up based on a preference tree has not fixed but versatile tree structure capable of dynamically performing conversion processes.

In step S123, when the job tree “J1” is built up, the refresh copy detecting activity 104 starts executing the job based on the job tree “J1”. First, the refresh copy detecting activity 104 sends a request to the terminal (distal) filter (which refers to the filter having no image pipe connected to the output of the filter) in the job tree “J1” to execute a process. Typically, the terminal filter is the output filter of the job tree “J1”. In this case, the marking analyzing filter 135 is the terminal filter in this job tree “J1”. Therefore, first, the request to execute a process is sent to the marking analyzing filter 135.

In step S124, upon receiving the request to execute a process, the marking analyzing filter 135 sends a request to the image pipe 21a connected to the input of the marking analyzing filter 135 in the job tree “J1” to input image data set. In step S125, since no input image data set is stored in the memory area managed by the image pipe 21a, the image pipe 21a sends a request to the reading filter 111 connected to the input of the image pipe 21a in the job tree “J1” to execute a process.

In step S126, to respond to the request, the reading filter 111 reads image data set from a draft by controlling the imaging section 604 in accordance with the operating conditions set in the reading preference 111p (that is, the reading conditions adapted to the reading of barcode). In step S127, the reading filter 111 outputs the read image data set to the image pipe 21a connected to the output of the reading filter 111 in the job tree “J1”. In step S128, in response to the input of the image data set, the image pipe 21a informs the marking analyzing filter 135 that the situation of the image pipe 21a has changed (in this case, image data set has been input to the image pipe 21a), the marking analyzing filter 135 having requested to the image pipe 21a to input image data set. In step S129, to respond to the notice, the marking analyzing filter 135 acquires the image data set from the image pipe 21a and analyzes the barcode embedded in the image data set based on the operating conditions (such as the marking type is “barcode”) set in the marking analyzing preference 135p. In step S130, in the analysis process, the marking analyzing filter 135 requests the marking analyzing service 25 to analyze the marking embedded in the image data set using the marking type (barcode), the barcode parameter 135p1, and the like as arguments. In step S131, the marking analyzing service 25 sends a request to the marking handling service 26 to detect a barcode in the detection region specified by the barcode parameter 135p1. In step S132, the marking handling service 26 detects a barcode in the specified detection region of the image data set and transmits the data (bit string) recorded in the detected barcode to the marking analyzing service 25 as the analysis result. In step S133, the marking analyzing service 25 transmits the analysis result data to the marking analyzing filter 135. In step S134, the marking analyzing filter 135 stores the analysis result and informs the refresh copy detecting activity 104 of the completion of the process. This is the end of the first job.

Next, in steps S135 and S136, the refresh copy detecting activity 104 acquires the data analyzed from the barcode from the marking analyzing filter 135. In step S137, the refresh copy detecting activity 104 handles the data (bit string) as the sheet ID and sends a request to the sheet tracing service 24 to acquire the document information associated with the sheet ID.

Next, in step S138, the sheet tracing service 24 searches for the document ID managed (by, for example, storing in the HDD 633) and associated with the sheet ID, and transmits the document information managed and associated with the document ID to the refresh copy detecting activity 104. Herein, the term “a document ID” refers to an ID assigned to each image data set 300 so that the bibliographic information (document information) is uniquely identified in the multi-functional peripheral 1 (within its local range), the bibliographic information including the image data set 310 stored in the HDD 633 in the embedding stage shown in FIG. 7A, a user name of the user who requested to store the image data set, date and time when the image data set is stored, name (machine name) of the multi-functional peripheral 1 that stores the image data set, and the like. On the other hand, since the purpose of the sheet ID is to globally identifying each sheet one by one, the sheet ID is assigned to each sheet in a manner so that each sheet ID is unique not only in the multi-functional peripheral 1 (within a local range) but also outside the multi-functional peripheral 1 (in a global range) This is because sheets may be freely circulated outside the multi-functional peripheral 1. The sheet tracing service 24 issues the sheet ID with respect to the image data set 300 in the embedding stage and associates and manages the sheet ID with the document ID of the image data set 300. Therefore, the sheet tracing service 24 can respond to the request in step S137 and transmit the document information corresponding to the sheet ID. It should be noted that the sheet tracing service 24 may transmit location information of the image data set included in the document information. The location information refers to the information for identifying the multi-functional peripheral 1 in which the image data set is located, and the IP address and the like may be used. The location information is identified based on the sheet ID. For example, the location information may be included in the sheet ID. In this case, the sheet tracing service 24 extracts the location information from the sheet ID input in step S137 and transmits the extracted location information in the document information.

Next, in step S139, the refresh copy detecting activity 104 builds up a preference tree of the second job by generating relationships between each of the preference objects based on the connecting relationships of the second job between the refresh copy detecting activity 104 and the each of the filters.

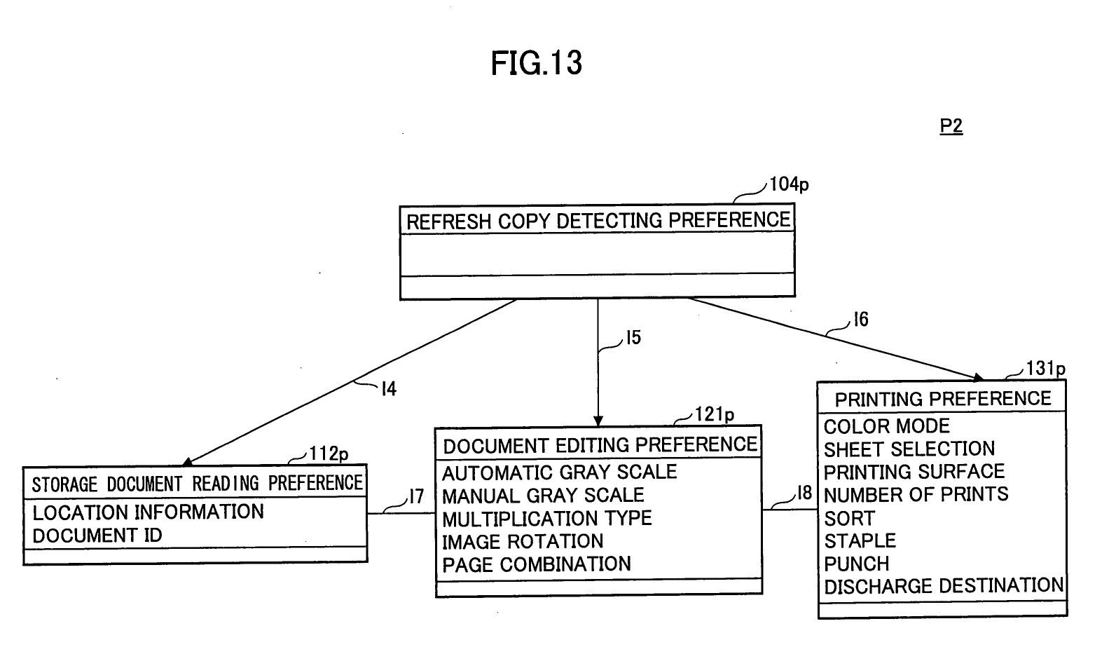

FIG. 13 shows an example of the preference tree “P2” of the second job of the refresh copy detecting activity 104. As shown in FIG. 13, the preference tree “P2” may include the refresh copy detecting preference 104p, a storage document reading preference 112p, the document editing preference 121p, and the printing preference 131p, which are the preference objects with respect to the refresh copy detecting activity 104, the storage document reading filter 112, the document editing filter 121, and the printing filter 131, respectively.

The storage document reading preference 112p includes parameters such as the location information and the document ID. The document editing preference 121p includes parameters such as automatic gray scale, manual gray scale, multiplication type, image rotation, and page combination. The printing preference 131p includes parameters such as color mode, sheet selection, printing surface, number of prints, sort, staple, punch, and discharge destination.

The relationships 14, 15, and 16 between the refresh copy detecting preference 104p and each of the other preference objects are generated based on the using relationship between the refresh copy detecting activity 104 and each of the filters. The relationships 17 and 18 between the filters are generated based on the sequential relationship in the execution order of the filters.

Next, in step S140, the refresh copy detecting activity 104 sends a request to the storage document reading filter 112 to set the location information and the document ID in the acquired document information in the reading conditions of the image data set. To respond to this request, the storage document reading filter 112 sets and stores the location information and the document ID into the storage document reading preference 112p as the operating conditions to specify the image data set to be read.

Next, in steps S141 and S142, the refresh copy detecting activity 104 generates image pipes 21 each connecting between filters based on the preference tree “P2”. In this case, based on the relationship 17 in the preference tree “p2”, an image pipe 21b is generated between the storage document reading filter 112 and the document editing filter 121; and, based on the relationship 18, an image pipe 21c is generated between the document editing filter 121 and the printing filter 131.

Next, in step S143, based on the preference tree “P2”, the refresh copy detecting activity 104 connects between the copy activity 101, each of the filters, and the image pipes 21 and builds up a job tree of the second job.

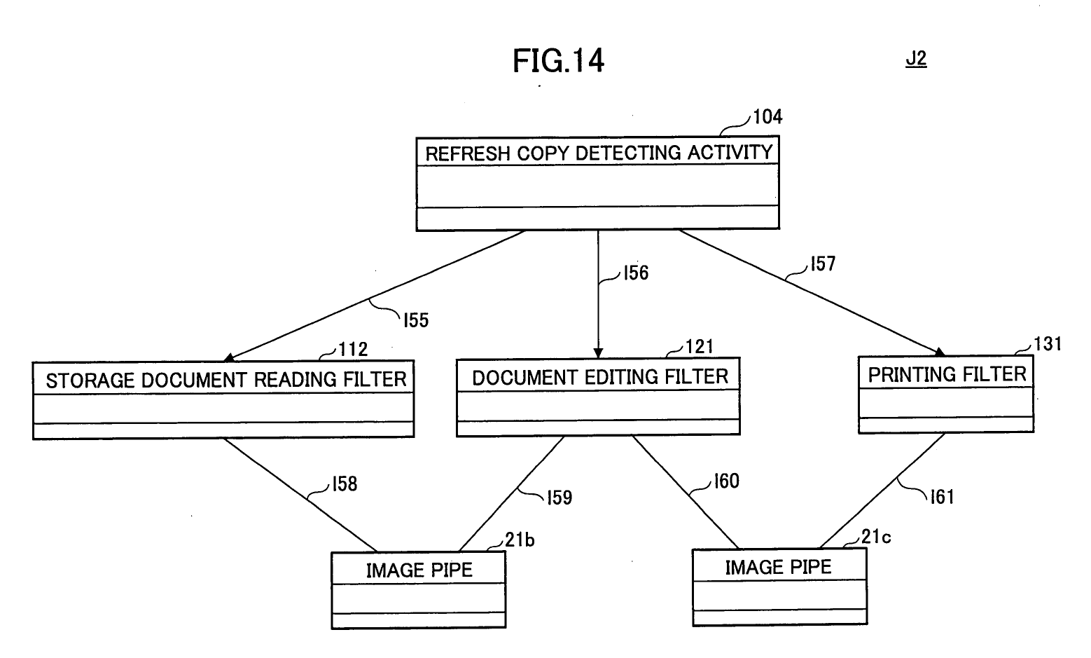

FIG. 14 shows an example of the job tree “J2” of the second job of the refresh copy detecting activity 104. As shown in FIG. 14, the job tree “J2” may include the refresh copy detecting activity 104, the storage document reading filter 112, the document editing filter 121, the printing filter 131, and the image pipes 21b and 21c.

The connections between the refresh copy detecting activity 104 and each of the filters (relationships 155, 156, and 157) are established based on the relationships 14, 15, and 16, respectively, in the preference tree “P2”. Further, the connection between the storage document reading filter 112 and the image pipe 21b (relationship 158) and the connection between the image pipe 21b and the document editing filter 121 (relationship 159) are established based on the relationship 17 in the preference tree “P2”. Further, the connection between the document editing filter 121 and the image pipe 21c (relationship 160) and the connection between the image pipe 21c and the printing filter 131 (relationship 161) are generated based on the relationship 18 in the preference tree “P2”.

In step S144, when the job tree “j2” is built up, the refresh copy detecting activity 104 starts the execution of the job based on the job tree “J2”. First, the refresh copy detecting activity 104 sends a request to the printing filter 131 which is the terminal (distal) filter in the job tree “J2” to execute a process.

In step S145, upon receiving the request to execute the process, the printing filter 131 sends a request to the image pipe 21c connected to the input of the printing filter 131 in the job tree “J2” to input one page of image data set. In step S146, since no input image data set is stored in the memory area managed by the image pipe 21c, the image pipe 21c sends a request to the document editing filter 121 connected to the input of the image pipe 21c in the job tree “J2” to execute a process. In step S147, the document editing filter 121 sends a request to the image pipe 21b connected to the input of the document editing filter 121 in the job tree “J2” to input image data set. In step S148, since no input image data set is stored in the memory area managed by the image pipe 21b, the image pipe 21b sends a request to the storage document reading filter 112 connected to the input of the image pipe 21b in the job tree “J2” to execute a process.

In step S149, to respond to the request, the storage document reading filter 112 reads (acquires) image data set specified by the document ID and the location information in the storage document reading preference 112p from the HDD 633. In step S150, the storage document reading filter 112 outputs the acquired image data set to the image pipe 21b connected to the output of the storage document reading filter 112. In this case, when it is determined that the image data set is stored outside the multi-functional peripheral 1 based on the location information, the storage document reading filter 112 acquires the image data set via a network. It should be noted that the image data set to be acquired herein is related to the sheet ID recorded in the barcode in the image data set read from the sheet document in the first job.

In step S151, in accordance with the input of the image data set, the image pipe 21b informs the document editing filter 121 which has requested the input of the image data set of the status change (in this case, the status that the image data set is input to the input pipe 21b). In step S152, to respond to the information, the document editing filter 121 acquires the image data set from the image pipe 21b and performs image processing with respect to the image data set based on the operating conditions in the document editing preference 121p with respect to acquired image data set. Next, in step S153, the document editing filter 121 outputs the image-processed image data set to the output pipe 21c connected to the output of the document editing filter 121. In step S154, in accordance with the input of the image data set, the image pipe 21c informs the printing filter 131 which has requested the input of the image data set of the status change (in this case, the status that the image data set is input to the input pipe 21c). In step S155, to respond to the information, the printing filter 131 acquires the image data set from the pipe filter 21c and prints the acquired image data set by controlling the printing section 605 based on the operating conditions set in the printing preference 131p. Next, in step S156, the printing filter 131 informs the refresh copy detecting activity 104 of the completion of the process. This is the end of the second job, and the reading stage of the refresh copy function is also finished. In the above description, it is assumed that one page is being copied. However, plural pages may also be copied by repeating the steps through S145 and S155.

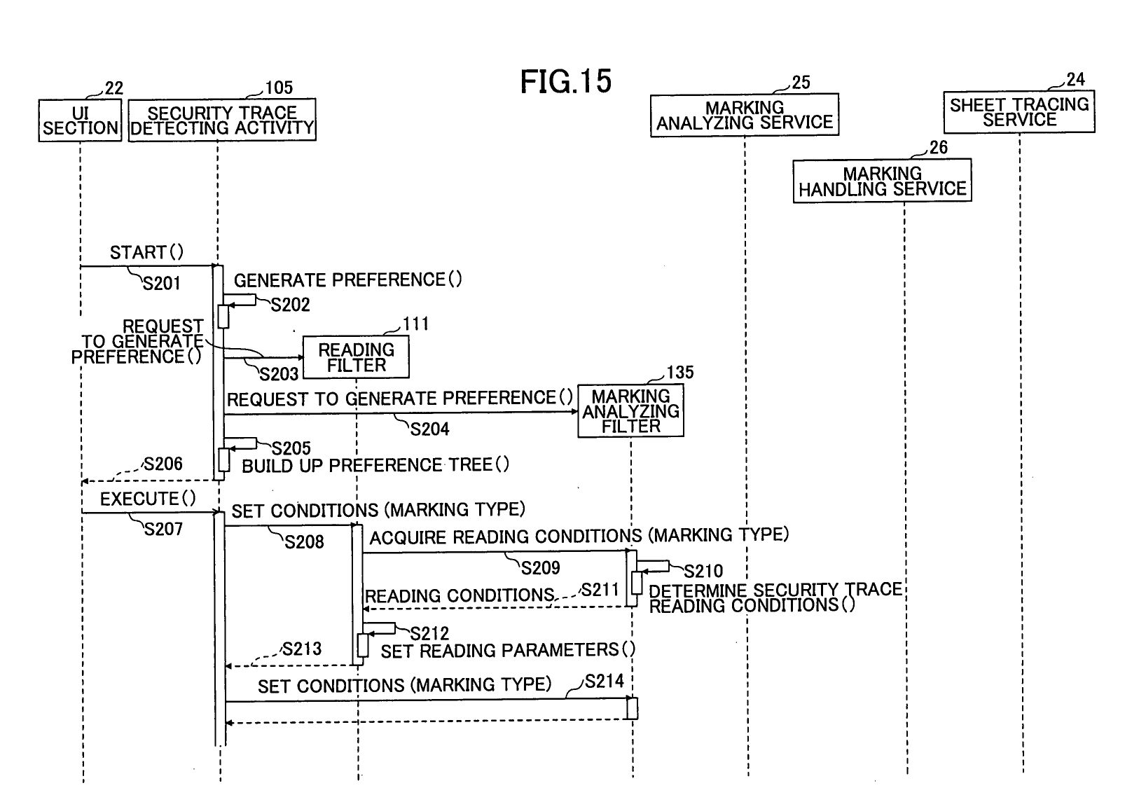

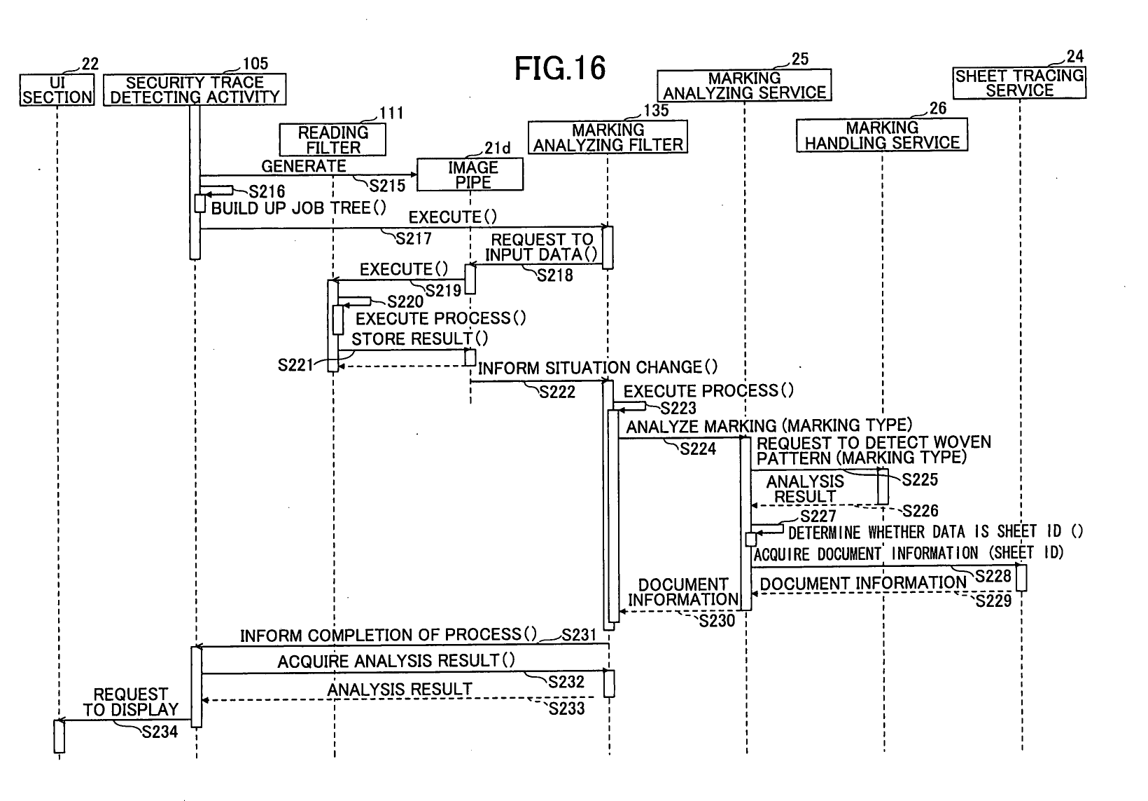

As a second embodiment of the present invention, a process of the security trace detecting activity 105 is described. FIGS. 15 and 16 are sequence diagram showing a process according to the second embodiment of the present invention.

In steps S201 through S204, in the same procedure as in steps S101 through S104 in FIG. 8, to respond to a request from the security trace detecting activity 105, the reading filter 111 and the marking analyzing filter 135 generate the reading preference 111p and the marking analyzing preference 135p, respectively. Next, in step S205, based on a connecting relationship defined between the security trace detecting activity 105 and each of the filters, the security trace detecting activity 105 builds up a preference tree by generating relationships between the preference objects.

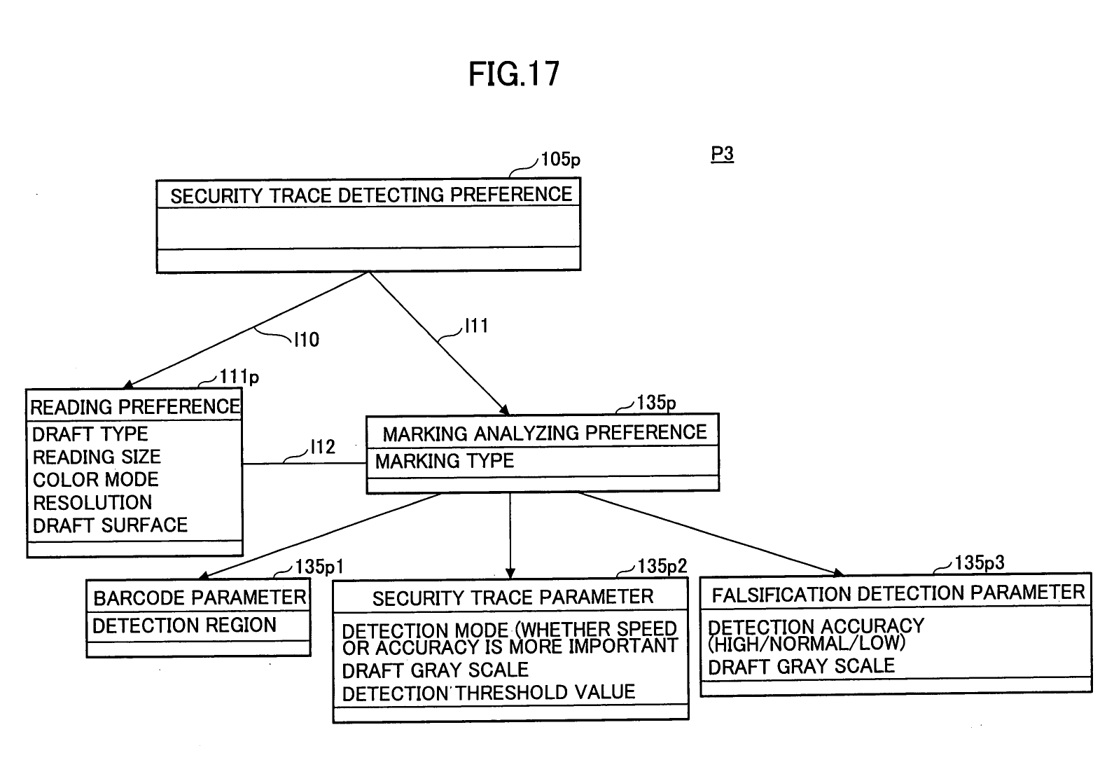

FIG. 17 shows an exemplary preference tree “P3” of the security trace detecting activity 105. In FIG. 17, the same reference numerals are used for the same or equivalent elements as used in FIG. 10, and the descriptions of the elements are herein omitted.

In FIG. 17, the preference tree “P3” may include a security trace detecting preference 105p, the reading preference 111p, and the marking analyzing preference 135p. The security trace detecting preference 105p is a preference object of the security trace detecting activity 105.

In the second embodiment of the present invention, the security trace parameter 135p2 is used among the parameters in the marking analyzing preference 135p. The security trace parameter 135p2 becomes effective when the marking type of the marking analyzing preference 135p is “security trace” and includes detection mode, draft gray scale, detection threshold value, and the like. The detection mode can be selected based on whether speed or accuracy is more important when a woven pattern is being detected. The draft gray scale is a parameter for correcting gray scale of an image. The draft gray scale may be effectively used because the woven pattern may become detected when the setting of the draft gray scale is adjusted. The detection threshold value is a threshold value of gray scale used when a woven pattern is being detected.

It should be noted that relationships 110 and 111 between the security trace detecting preference 105p and each of the other preference objects are generated based on the using relationships between the security trace detecting activity 105 and each of the corresponding filters. The relationship 112 between the preferences is generated based on the sequential relationship in the execution order of the filters.

In step S206, when the process to respond to the request to run is completed, the UI section 22 displays a menu to prompt a user to press a start button on the operations panel 602. Next, in step S207, when a request to start the job is input by a user by the pressing the start button, the UI section 22 sends a request to the security trace detecting activity 105 to run the job. In step S208, to respond to the request, by using the “security trace” as an argument of the marking type, the security trace detecting activity 105 sends a request to the reading filter 111 to set appropriate operating conditions corresponding to the marking type.

In step S209, the same as in the first embodiment, to respond to the request, the reading filter 111 sends a request to the marking analyzing service 25 to return appropriate operating conditions (reading conditions) to read the selected marking type (security trace). In step S210, the marking analyzing service 25 determines appropriate reading conditions to read the security trace woven pattern. Then, in step S211, the marking analyzing service 25 transmits the reading conditions as a result of the determination to the reading filter 111. In step S212, the reading filter 111 sets the received reading conditions in the reading preference 111p.

In step S213, the setting of the operating (reading) conditions is finished. Then, in step S214, the security trace detecting activity 105 sends a request to the marking analyzing filter 135 to set the operating conditions in accordance with the marking type using the marking type (security trace) as an argument. To respond to the request, the marking analyzing filter 135 sets a value of the marking type to be “security trace” and sets a value of each parameter of the security trace parameter 135p2.

Then, in step S215, based on the preference tree “P3”, the security trace detecting activity 105 generates an image pipe 21 for connecting filters used in the job. Herein, based on a relationship 112 in the preference tree “P3” of FIG. 17, the image pipe 21d connecting the reading filter 111 and the marking analyzing filter 135 is generated.

Next, in step S216, based on the preference tree “P3”, the security trace detecting activity 105 builds up a job tree by establishing the connections between the security trace detecting activity 105, each filter, and the image pipe 21a.

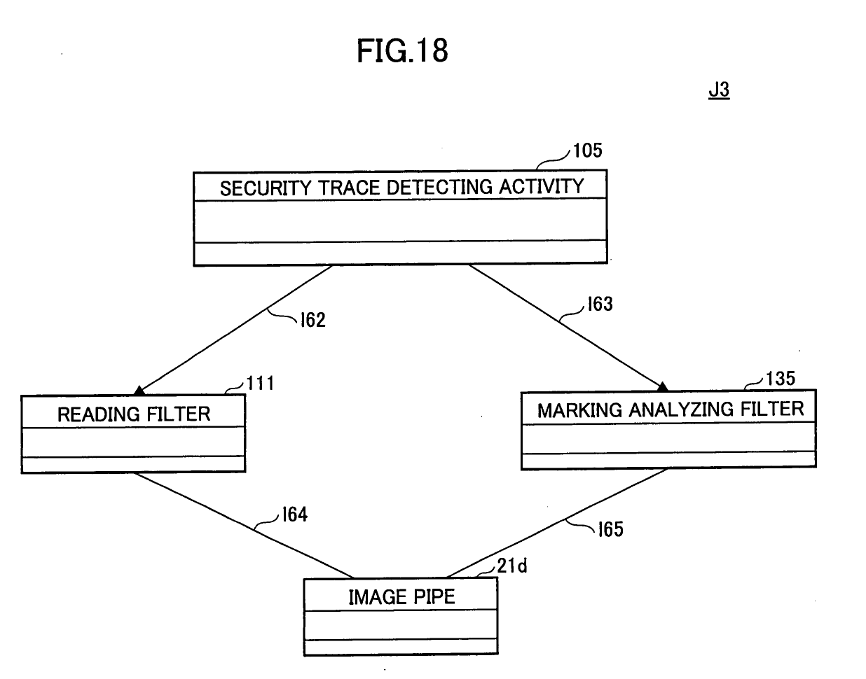

FIG. 18 shows an example of a job tree “J3” with respect to the security trace detecting activity 105. As shown in FIG. 18, the job tree “J3” may include the security trace detecting activity 105, the reading filter 111, the marking analyzing filter 135, and the image pipe 21d.

The connections (relationships 162 and 163) between the security trace detecting activity 105 and each of the filters are established based on the relationships 110 and 111, respectively, in the preference tree “P3”. Further, each of the connection (relationship 164) between the reading filter 111 and the image pipe 21d and the connection (relationship 165) between the image pipe 21d and the marking analyzing filter 135 is established based on the relationship 112 in the preference tree “P3”.

In step S217, when the job tree “J3” is built up, the security trace detecting activity 105 starts executing the job based on the job tree “J3”. First, the security trace detecting activity 105 sends a request to the marking analyzing filter 135 which is the terminal (distal) filter in the job tree “J3” to execute a process. In steps S218 through S222, an image data set is read (acquired) in the same manner as in steps S124 through S128 of FIG. 8, and the status change of the image pipe 21d (in this case, the status that image data set is input into the image pipe 21d) is reported to the marking analyzing filter 135. It should be noted that in step S220, the image data set is read (acquired) based on the reading conditions adapted for reading the woven pattern for the security trace.

In step S223, to response to the information from the image pipe 21d, the marking analyzing filter 135 acquires the image data set from the image pipe 21d and analyzes the woven pattern embedded in the image data set based on the operating conditions (the marking type is “security trace” and the like) in the marking analyzing preference 135p. In step S224, in the analysis process, the marking analyzing preference 135p requests the marking analyzing service 25 to analyze the marking embedded in the image data set using the marking type (security trace), the security trace parameter 135p2, and the like as arguments. In step S225, the marking analyzing service 25 sends a request to the marking handling service 26 to detect a woven pattern by specifying the marking type (security trace) and the parameter in the security trace parameter 135p2. In step S226, the marking handling service 26 detects the woven pattern from the image data set based on the specified parameter and transmits the data (bit string) recorded in the detected woven pattern to the marking analyzing service 25 as the analysis result.

In step S227, the marking analyzing service 25 determines whether the transmitted data (namely, data embedded in the woven pattern) is a sheet ID, more specifically, whether the data are appropriate as a value of the sheet ID (whether the data have a structure of the sheet ID). In step S228, when it is determined that the data are one of the sheet IDs, the marking analyzing service 25 sends a request to the sheet tracing service 24 to acquire document information using the sheet ID as an argument. In step S229, the sheet tracing service 24 acquires the document information related to the document ID associated with the specified sheet ID and transmits the acquired document information to the marking analyzing service 25. In step S230, the marking analyzing service 25 transmits the received document information to the marking analyzing filter 135 as the analysis result.

On the other hand, when it is determined that the data from the marking handling service 26 is not one of the sheet IDs in step S227, the marking analyzing service 25 transmits the data as that are in step S230. In this embodiment, it is assumed that the information embedded in the woven pattern as a security trace is the document information. Therefore, in any case, the document data are transmitted to the marking analyzing filter 135 in step S230.

Then, in step S231, the marking analyzing filter 135 stores the document information as the analysis result and informs the security trace detecting activity 105 of the completion of the process. Next, in steps S232 and S233, the security trace detecting activity 105 acquires the document information analyzed from the woven pattern. In step S234, the security trace detecting activity 105 causes the UI section 22 to display the document information. By doing this, a security trace detection menu showing the result of analyzing the security trace is displayed on the operations panel 602.

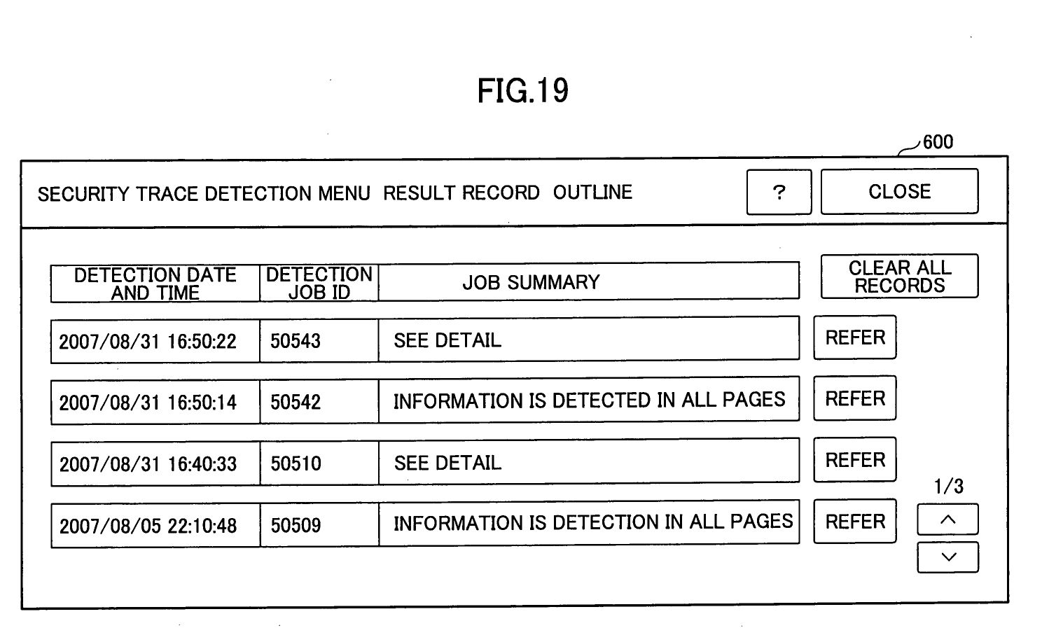

FIG. 19 shows an example of the security trace detection menu. As shown in FIG. 19, the security trace detection menu 600 shows a list of the analysis result including not only the job executed this time but also jobs executed before. Namely, the security trace detection menu 600 includes detection date and time, detection job ID, job summary, and a reference button for each analysis result (each job). The detection date and time indicates when the job in FIGS. 15 and 16 is executed. The detection job ID is the same as the job ID. The job summary is a message of an outline of the job result. When one of the reference buttons is pressed, the UI section 22 displays the document information analyzed (extracted) from the woven pattern in the corresponding job. It should be noted the analysis result and the like may be stored in the HDD 633 by the security trace detecting activity 105 so as to display the detection results of the past jobs.

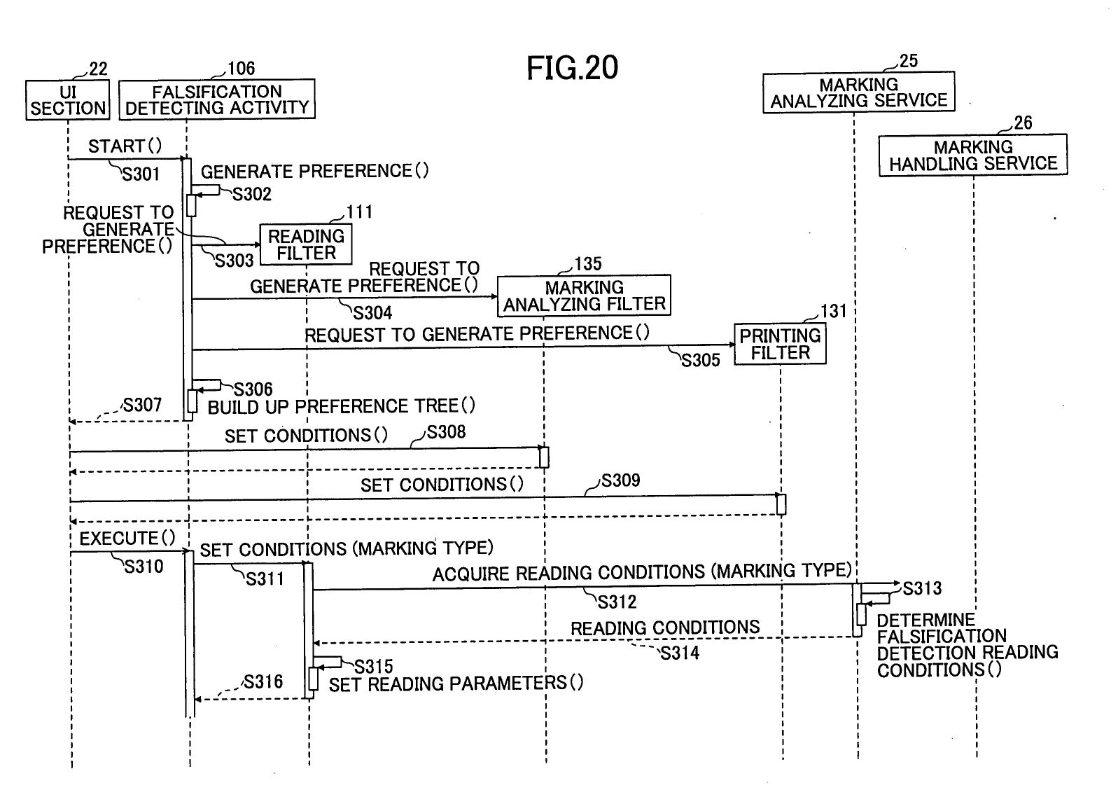

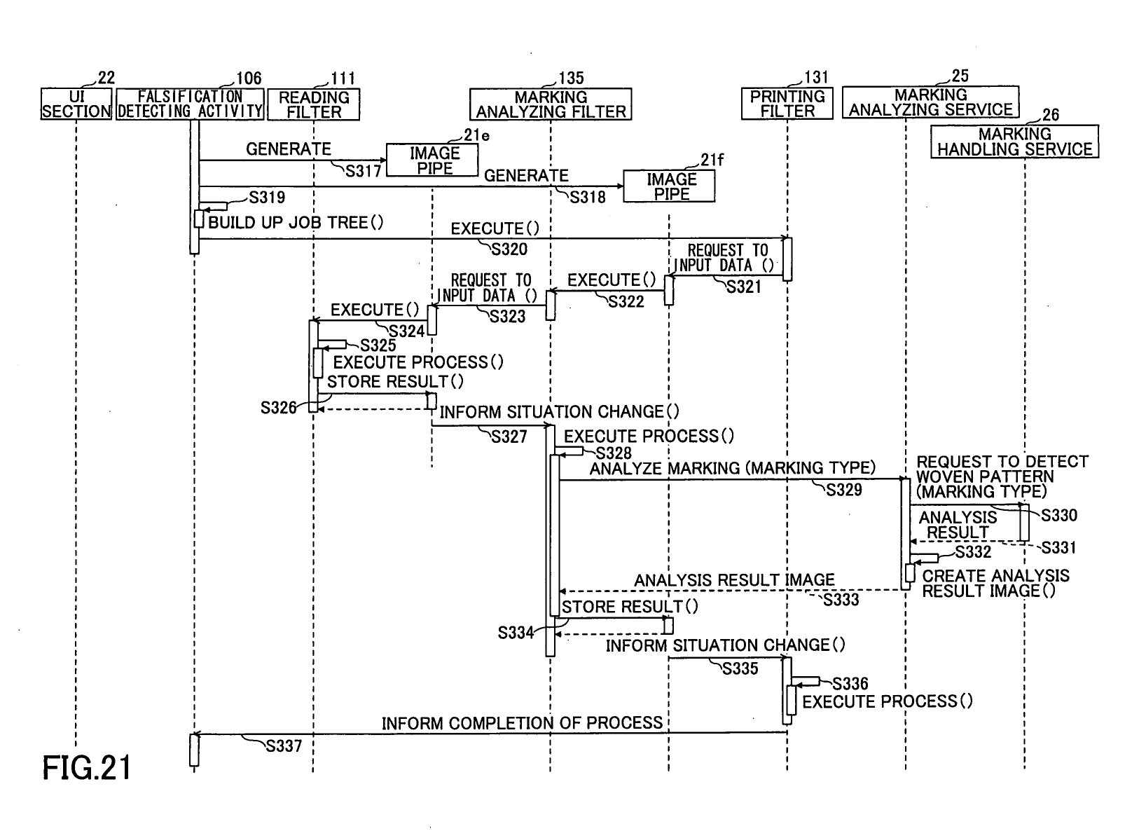

As a third embodiment of the present invention, a process of the falsification detecting activity 106 is described. FIGS. 20 and 21 are sequence diagram showing a process according to the third embodiment of the present invention.

In steps S301 through S305, in the same procedure as in steps S101 through S104 and S107 in FIG. 8, to respond to a request from the falsification detecting activity 106, the reading filter 111, the marking analyzing filter 135, and printing filter 131 generate the reading preference 111p, the marking analyzing preference 135p, and the printing preference 131p, respectively. Next, in step S306, based on a connecting relationship defined between the falsification detecting activity 106 and each of the filters, the falsification detecting activity 106 builds up a preference tree by generating relationships between the preference objects.

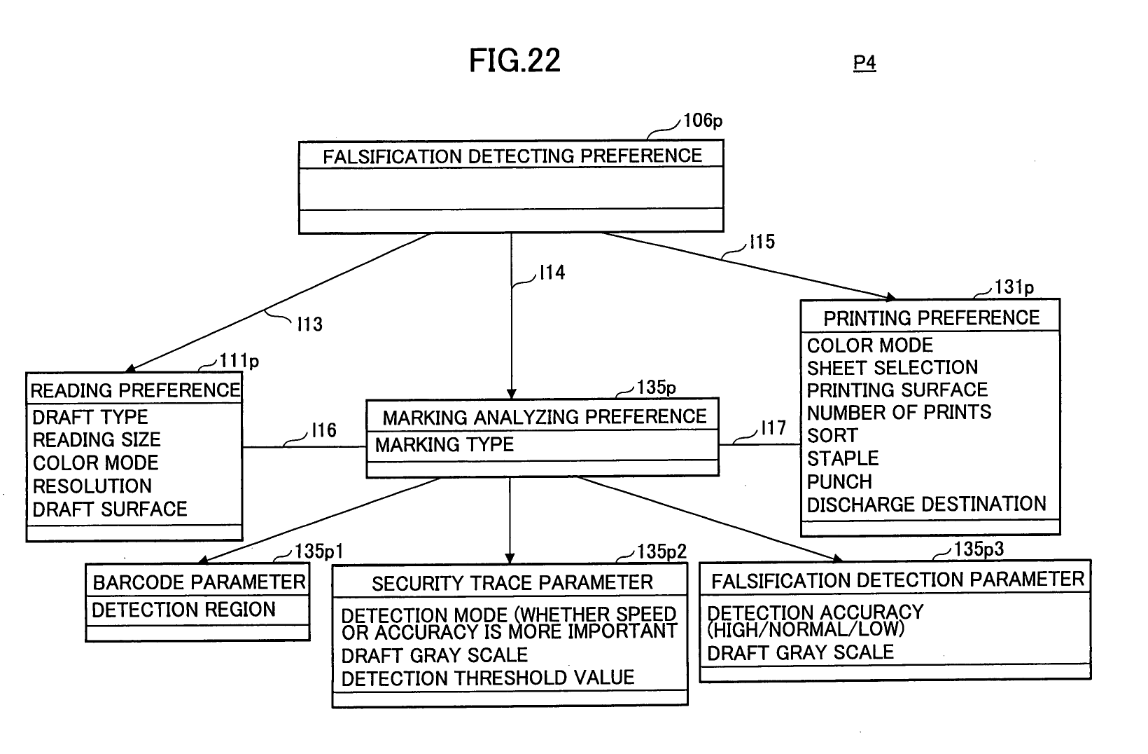

FIG. 22 shows an exemplary preference tree “P4” of the falsification detecting activity 106. In FIG. 22, the same reference numerals are used for the same or equivalent elements as used in FIGS. 10 or 13, and the descriptions of the elements are herein omitted.

In FIG. 22, the preference tree “P4” may include a falsification detecting preference 106p, the reading preference 111p, the marking analyzing preference 135p, and the printing preference 131p. The falsification detecting preference 106p is a preference object of the falsification detecting activity 106.

In the third embodiment of the present invention, the falsification detection parameter 135p3 is used among the parameters in the marking analyzing preference 135p. The falsification detection parameter 135p3 becomes effective when the marking type of the marking analyzing preference 135p is “falsification detection” and includes detection accuracy, draft gray scale, and the like. The detection accuracy indicates accuracy of detecting a woven pattern. The draft gray scale has the same meaning as that of the draft gray scale in the security trace parameter 135p2.

The relationships 113, 114, and 115 between the falsification detecting preference 106p and each of the other preference objects are generated based on the using relationships between the falsification detecting activity 106 and each of the corresponding filters. The relationships 116 and 117 between the preferences are generated based on the sequential relationship in the execution order of the filters. In step S307, when the process to respond to the request to run is completed, the UI section 22 displays an operations menu (falsification detection operations menu) of the falsification detecting activity 106 on the operations panel 602 based on an activity UI of the falsification detecting activity 106.

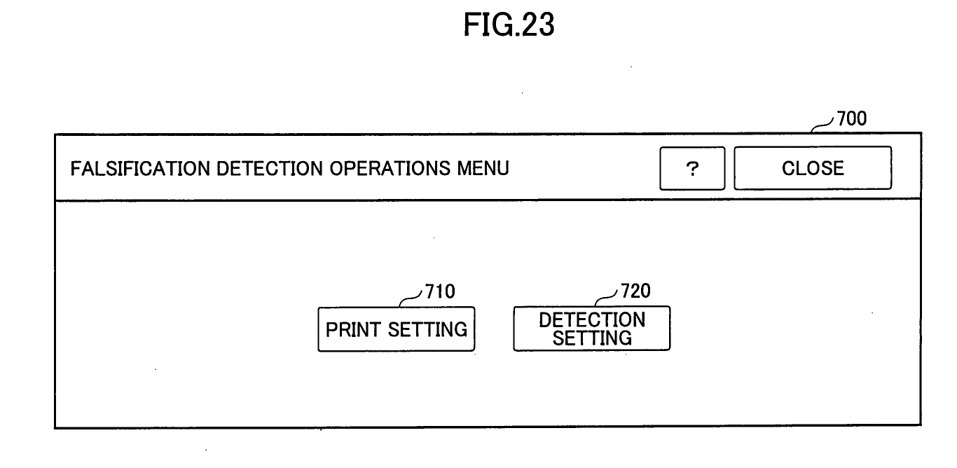

FIG. 23 is an example of the falsification detection operations menu 700. As shown in FIG. 23, the falsification detection operations menu 700 includes a print setting button 710 and a detection setting button 720.

In step S308, when the detection setting button 720 is pressed, the UI section 22 displays a menu for setting the falsification detection parameter 135p3 as shown in FIG. 22 based on the filter setting UI of the marking analyzing filter 135. When each value of the parameters is set in this menu, the UI section 22 informs the marking analyzing filter 135 of the setting contents and sends a request to the marking analyzing filter 135 to set the “falsification detection” as the marking type. The marking analyzing filter 135 sets the informed setting contents to the falsification detection parameter 135p3 and sets the “falsification detection” as the marking type of the falsification detection parameter 135p3.

On the other hand, in step S308, when the print setting button 710 is pressed, the UI section 22 displays a menu for setting the parameters of the printing preference 131p as shown in FIG. 22 based on the filter setting UI of the printing filter 131. When each parameter value is set in the menu, the UI section 22 informs the printing filter 131 of the setting contents. The printing filter 131 sets the informed setting contents in the printing preference 131p.

Next, in step S310, when the start button on the operations panel 602 is pressed by a user to start the job, the UI section 22 sends a request to the falsification detecting activity 106 to run the job. In step S311, to respond to the request, by using the “falsification detection” as an argument of the marking type, the falsification detecting activity 106 sends a request to the reading filter 111 to set appropriate operating conditions corresponding to the marking type to the reading filter itself.

In step S312, same as in the first and the second embodiments, to respond to the request, the reading filter 111 sends a request to the marking analyzing service 25 to return appropriate operating conditions (reading conditions) to read the selected marking type (falsification detection). In step S313, the marking analyzing service 25 determines appropriate reading conditions to read the woven pattern for falsification detection. Then, in step S314, the marking analyzing service 25 transmits the reading conditions as a result of the determination to the reading filter 111. In step S315, the reading filter 111 sets the received reading conditions in the reading preference 111p.

In steps S317 and S318, the falsification detecting activity 106 generates the image pipes 21 for connecting between filters based on the preference tree “P4”.

Then, in step S215, based on the preference tree “P4”, the falsification detecting activity 106 generates the image pipes 21 for connecting filters. Herein, based on the relationship 116 in the preference tree “P4”, the image pipe 21e connecting the reading filter 111 and the marking analyzing filter 135 is generated. In the same manner, based on the relationship 117, the image pipe 21f connecting the marking analyzing filter 135 and printing filter 131 is generated.

Next, in step S319, based on the preference tree “P4”, the falsification detecting activity 106 builds up a job tree by establishing the connections between the falsification detecting activity 106, each filter, and the image pipes 21e and 21f.

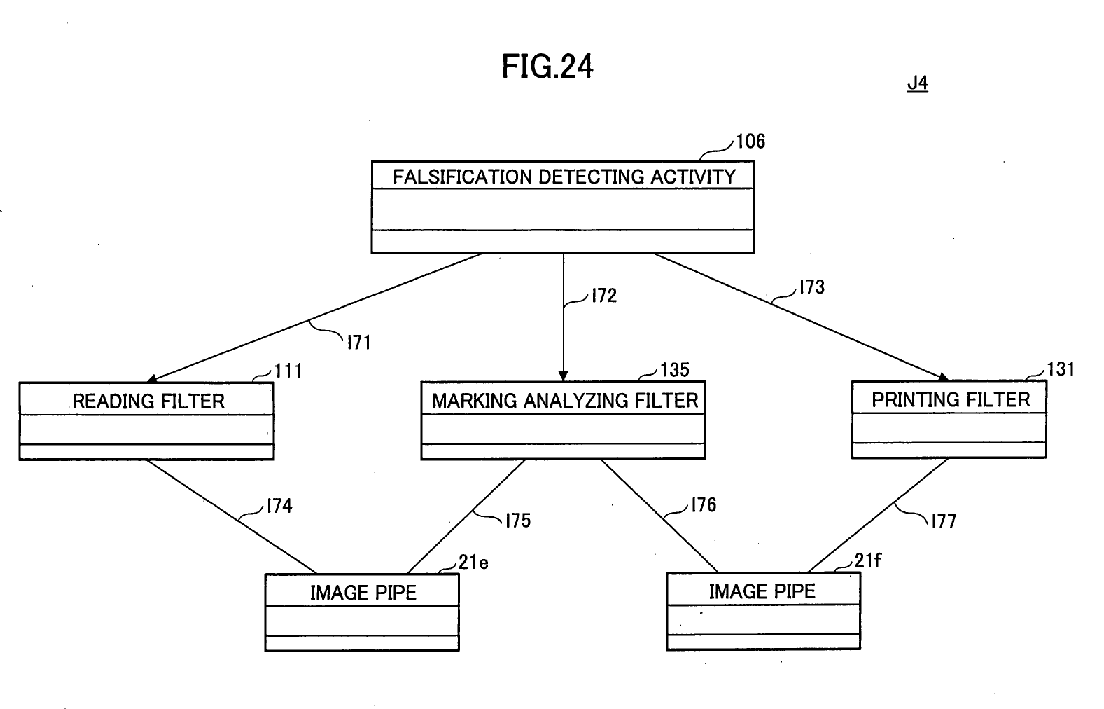

FIG. 24 shows an example of a job tree “J4” with respect to the falsification detecting activity 106. As shown in FIG. 24, the job tree “J4” may include the falsification detecting activity 106, the reading filter 111, the marking analyzing filter 135, the printing filter 131, and the image pipes 21e and 20f.

The connections (relationships 171, 172, and 173) between the falsification detecting activity 106 and the corresponding filters are established based on the relationships 113, 114, and 115, respectively, in the preference tree “P4”. Further, each of the connection (relationship 174) between the reading filter 111 and the image pipe 21e and the connection (relationship 175) between the image pipe 21e and the marking analyzing filter 135 is established based on the relationship 116 in the preference tree “P4”. Further, each of the connection (relationship 176) between the marking analyzing filter 135 and the image pipe 21f and the connection (relationship 177) between the image pipe 21f and the printing filter 131 is established based on the relationship 117 in the preference tree “P4”.

In step S320, when the job tree “J4” is built up, the falsification detecting activity 106 starts executing the job based on the job tree “J4”. First, the falsification detecting activity 106 sends a request to the printing filter 131 which is the terminal (distal) filter in the job tree “J4” to execute a process.

In step S321, upon receiving the request to execute the process, the printing filter 131 sends a request to the image pipe 21f connected to the input of the printing filter 131 in the job tree “J4” to input one page of image data set. In step S322, since no input image data set is stored in the memory area managed by the image pipe 21f, the image pipe 21f sends a request to marking analyzing filter 135 connected to the input of the image pipe 21f in the job tree “J4” to execute a process. In step S323, the marking analyzing filter 135 sends a request to the image pipe 21e connected to the input of the marking analyzing filter 135 in the job tree “J4” to input image data set. In step S324, since no input image data set is stored in the memory area managed by the image pipe 21e, the image pipe 21e sends a request to the reading filter 111 connected to the input of the image pipe 21e in the job tree “J4” to execute a process.

In steps S325 through S327, an image data set is read (acquired) in the same manner as in steps S126 through S128, and the status change in the image pipe 21e (in this case, status that the image data set is input to the image pipe 21e) is transmitted to the marking analyzing filter 135. It should be noted that, in step S325, the image data set is read based on the reading conditions adapted to read the woven pattern for falsification detection.

In step S328, to respond to the information, the marking analyzing filter 135 acquires the image data set from the image pipe 21e and analyzes the woven pattern embedded in the image data set based on the operating conditions (marking type is “falsification detection” and the like) in the marking analyzing preference 135p. In step S329, in the analysis process, the marking analyzing filter 135 requests the marking analyzing service 25 to analyze the marking embedded in the image data set using the marking type (falsification detection), the marking analyzing preference 135p, and the like as arguments. In step S330, the marking analyzing service 25 sends a request to the marking handling service 26 to detect a woven pattern by specifying the marking type (falsification detection) and the parameter in the marking analyzing preference 135p. In step S331, the marking handling service 26 detects the woven pattern from the image data set based on the specified parameter and determines whether there is falsification in the information (sentence, figure, and the like) recorded as drawing elements of the image data set. When it is determined that there is falsification, the position (region) of the falsification is analyzed. The marking handling service 26 transmits the analysis result to the marking analyzing service 25. It should be noted that such a known technique as described in Japanese Patent Application Publication Nos. 2005-12530 or 2005-19214 may be used for detecting the falsification and determining the position of the falsification of woven patterns.

In step S332, when the analysis result from the marking handling service 26 shows that falsification is detected, the marking analyzing service 25 performs image processing so that the position of the detected falsification becomes observable by putting a mark on the position by, for example, surrounding the falsified position with a rectangle or a circle having a remarkable color such as red. Next, in step S333, the marking analyzing service 25 transmits either image data set on which no image processing to highlight the falsified position is performed when no falsification is detected or an image data set on which the image processing to highlight the falsified position is performed when the falsification is detected (hereinafter both image data set are generically referred to as “analysis result image data set”) to the marking analyzing filter 135.

Next, in step S334, the marking analyzing filter 135 outputs the acquired analysis result image data set to the image pipe 21f connected to the output of the marking analyzing filter 135 in the job tree “J4”. In step S335, in accordance with the input of the analysis result image data set, the image pipe 21f informs the printing filter 131 of the status change (in this case, the status that image data set is input to the input pipe 21f). In step S336, to respond to the information, the printing filter 131 acquires the analysis result image data set from the image pipe 21f and prints the acquired analysis result image data set by controlling the printing section 605 based on the operating conditions in the printing preference 131p. As a result, when falsification is detected, a mark showing the falsification position is additionally printed on the printing result. Next, in step S337, the printing filter 131 informs the falsification detecting activity 106 of the completion of the process.

As described above, in a multi-functional peripheral 1 according to an embodiment of the present invention, each function may be constructed (created) by using filters as parts. Because of this feature, it becomes possible to customize or expand a function easily. Namely, since each filter is independent of the others, a new function (application) may be easily developed by adding a new filter or changing the combination of the filters. Because of this feature, when a new application is required to be implemented and only a part of the processes of the application is not implemented, only the filter for realizing the lacking process is required to be developed and installed.

Therefore, for example, in a case where a function of analyzing the marking embedded in image data set read from a sheet document as described in the embodiment of the present invention is required to be implemented, only the marking analyzing filter 135 may be added and the existing reading filter 111 may be used for reading image data set, thereby improving the efficiency of the development.

Further, by defining a function by combining filters as an activity, it becomes possible to use the function of the combined filters by simple operations.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

The present application is based on and claims the benefit of priority of Japanese Patent Application No. 2007-284201, filed on Oct. 31, 2007, the entire contents of which are hereby incorporated herein by reference.

What is claimed is:

1. An image forming apparatus comprising:
a parts controlling unit causing software parts to execute a process based on connecting relationships each relationship related to input/output of information between the software parts;
an image data set acquiring unit, as one of the software parts, acquiring image data set and outputting the acquired image data set to the software parts connected to an output of the image data set acquiring unit in the connecting relationships; and
an information extracting unit, as one of the software parts, extracting information recorded in a pattern embedded in the image data set input from the software parts connected to an input of the information extracting unit in the connecting relationships, wherein
the parts controlling unit connects the information extracting unit at the output of the image data set acquiring unit.

2. The information processing apparatus according to claim 1, further comprising:
a reading condition determining unit determining reading conditions of image data set from a sheet document based on a type of the pattern, wherein
the image data set acquiring unit reads image data set from the sheet document based on the reading conditions determined by the reading condition determining unit.

3. The information processing apparatus according to claim 1, further comprising:
an image data set reading unit, as one of the software parts, reading image data set stored in a storage unit and outputting the read image data set to the software parts connected to an output of the image data set reading unit in the connecting relationships; and
a print controlling unit, as one of the software parts, causing a printing device to print image data set input from the software parts connected to an input of the print controlling unit in the connecting relationships, wherein
the parts controlling unit connects the print controlling unit at the output of the image data set reading unit and the parts controlling unit causes the image data set reading unit to read image data set associated with the information extracted by the information extracting unit.

4. The information processing apparatus according to claim 1, wherein
the parts controlling unit displays the information extracted by the information extracting unit on a display device.

5. The information processing apparatus according to claim 1, wherein
the information extracting unit determines whether drawing elements in the image data set are falsified based on the extracted information.

6. A computer-executable information processing method comprising:
a parts controlling step of causing software parts to execute a process based on connecting relationships each relationship related to input/output of information between the software parts;
an image data set acquiring step where an image data set acquiring unit, as one of the software parts, acquires image data set and outputs the acquired image data set to the software parts connected to an output of the image data set acquiring unit in the connecting relationships; and
an information extracting step where an information extracting unit, as one of the software parts, extracts information recorded in a pattern embedded in the image data set input from the software parts connected to an input of the information extracting unit in the connecting relationships, wherein
in the parts controlling step, the information extracting unit is connected at the output of the image data set acquiring unit.

7. The computer-executable information processing method according to claim 6, further comprising:
a reading condition determining step of determining reading conditions of image data set from a sheet document based on a type of the pattern, wherein
in the image data set acquiring step, the image data set are read from the sheet document based on the reading conditions determined in the reading condition determining step.

8. The computer-executable information processing method according to claim 6, further comprising:
an image data set reading step where an image data set reading unit, as one of the software parts, reads image data set stored in a storage unit and outputs the read image data set to the software parts connected to an output of the image data set reading unit in the connecting relationships; and
a print controlling step where a print controlling unit, as one of the software parts, causes a printing device to print image data set input from the software parts connected to an input of the print controlling unit in the connecting relationships, wherein
in the parts controlling step, the print controlling unit is connected at the output of the image data set reading unit and in the image data set reading step, the image data set associated with the information extracted in the information extracting step is read.

9. The computer-executable information processing method according to claim 6, wherein
in the parts controlling unit step, the information extracted in the information extracting step is displayed on a display device.

10. The computer-executable information processing method according to claim 6, wherein
in the information extracting step, it is determined whether drawing elements in the image data set are falsified based on the extracted information.
